(19) United States
(12) Patent Application Publication
(10) Pub. No.: US 2024/0142321 A1
(43) Pub. Date: May 2, 2024

(54) Soft Pressure Sensor Array

(71) Applicant: Board of Trustees of Michigan State University, East Lansing, MI (US)

(72) Inventors: Xiaobo TAN, Okemos, MI (US); Hongyang SHI, Austin, TX (US); Nelson SEPULVEDA, Haslett, MI (US); Claudia CHEN, Canton, MI (US); Yu MEI, East Lansing, MI (US)

(73) Assignee: Board of Trustees of Michigan State University, East Lansing, MI (US)

(21) Appl. No.: 18/378,230

(22) Filed: Oct. 10, 2023

Related U.S. Application Data
(60) Provisional application No. 63/416,036, filed on Oct. 14, 2022.

(51) Int. Cl. G01L 1/18; G01L 5/00; G06N 3/044; G06N 3/08

(52) U.S. Cl. CPC G01L 1/18; G01L 5/0061; G06N 3/044; G06N 3/08

(57) ABSTRACT

A soft pressure sensing apparatus is provided. In one aspect of the present pressure sensing apparatus, a polymeric member, including conductive particles therein, is located between offset angled and crossing sets of electrodes. A further aspect includes a controller configured to calculate at least one regularized least-squares algorithm, to reduce cross-talk between the resistive members. In another aspect, a pressure sensor apparatus includes a piezoresistive film encapsulated between layers of substantially perpendicular electrodes to create a resistor network circuit where the ability to reconstruct cell resistance from measured two-point resistance. A method of manufacturing a pressure sensor includes using a mechanical vinyl cutter for the electrodes and/or piezoelectric resistive members.

### CROSS-REFERENCE TO RELATED APPLICATION

The present application claims priority to U.S. Provisional Patent Application Ser. No. 63/416,036 filed on Oct. 14, 2022, which is incorporated by reference herein.

### BACKGROUND AND SUMMARY

The present disclosure generally pertains to a sensor apparatus and more particularly to a soft pressure sensor array.

A traditional sensor is disclosed in U.S. Pat. No. 6,964,205 entitled “Sensor with Plurality of Sensor Elements Arranged with Respect to a Substrate” which was issued to Papakostas, et al. on Nov. 15, 2005, and is incorporated by reference herein. This patent discloses multiple spiraling sensor elements with surrounding conductive traces connecting the sensor elements, all on a flexible substrate having slits therein. Various configurations to overcome tear weakness points and slit propagation in the substrate are also discussed, but are a disadvantage of this traditional sensor.

Another soft sensor is disclosed in U.S. Patent Publication No. 2022/0066441, published on Mar. 3, 2022, entitled “Flexible Sensor” and was invented by common inventor Tan, et al. This patent publication discloses a flexible sensor employing flexible films, and an electrically resistive and compressible polymer. This patent publication is incorporated by reference herein.

In an exemplary use, attachment by oral suction is a prominent characteristic of sea lampreys. They not only rely on oral suction to parasitize other fish, but frequently attach to artificial and natural substrates like rocks during upstream migration and nest building. Interdigitated electrode contact sensors have recently been tried for sea lamprey detection, with characteristic responses when a lamprey attaches to the sensor. However, such interdigitated electrode sensors do not provide sufficiently granular information such as the suction strength. Another conventional soft stretchable sensor device was made of elastomers with conductive hydrogels or nanomaterials to measure pressure, stress and strain. However, this approach has been limited to compressive load or tensile stretch and does not respond to a suction stimulus.

It is noteworthy that electromagnetic interference (“EMI”) becomes severe for underwater animal tests since water and animal tissues are both conductive. This interference will cause difficulty in extracting the actual contacting profile in some traditional sensors unless sophisticated and expensive EMI shielding layers are integrated with the sensor devices. Moreover, conventional piezoelectric pressure sensors only respond well to a dynamic change of pressure and are not particularly effective for quasi-static pressure sensing.

In accordance with the present invention, a soft pressure sensing apparatus is provided. In one aspect of the present pressure sensing apparatus, a polymeric member, including conductive particles therein, is located between offset angled and crossing sets of electrodes. A further aspect includes a controller configured to calculate at least one regularized least-squares algorithm which computes resistance values of resistive members based on a matrix of measured resistance values between selected rows and selected columns of the electrodes, to reduce cross-talk between the resistive members.

In another aspect, a pressure sensor apparatus includes a piezoresistive film encapsulated between layers of substantially perpendicular electrodes to create a resistor network circuit with the ability to reconstruct cell resistance from measured two-point resistance. A further aspect provides a flexible pressure sensor including piezoresistive material between offset angled electrodes which can be water-proof encapsulated, and use passive matrices and/or account for intrinsic crosstalk with a signal processing circuit. A method of using a pressure sensor, including accounting for crosstalk with signal processing is also provided.

A method of manufacturing a high-resolution pressure sensor is provided in yet another aspect, which includes cutting piezoresistive film and/or metallic electrodes. Once such exemplary cutting device is a mechanical vinyl cutter. The present cutting method is considerably less expensive as compared to conventional conductive ink printing, photo etching, chemical etching and screen printing. Furthermore, the present cutting method advantageously allows for easy customization of piezoresistive film and/or electrode shapes for different locations or uses.

The present apparatus and methods are advantageous over conventional devices. For example, the present sensor can beneficially detect small or soft external pressures (including suction negative pressures) and provide high resolution measured data therefrom. Moreover, the present apparatus is durable, waterproof and usable in submerged locations. The present soft sensors possess high sensitivity, reliability, flexibility, and moderate cost. Additional advantageous and features of the present system and method will become apparent from the following description and appended claims, taken in conjunction with the accompanying drawings.

### BRIEF DESCRIPTION OF THE DRAWINGS

FIG. 1 is a true elevational view showing the present sensor apparatus;

FIG. 2 is a perspective view showing the present sensor apparatus;

FIG. 3 is an exploded perspective view showing the present sensor apparatus;

FIGS. 4A-C are diagrammatic and exaggerated side views showing the present sensor apparatus, in a relaxed nominal state, compressed pressure state and suction negative pressure state, respectively;

FIG. 5 is a simplified diagrammatic and perspective view showing the present sensor apparatus, under compressive pressure;

FIG. 6 is a diagrammatic and exaggerated side view showing the present sensor apparatus, with a simulating suction cup applying negative pressure;

FIG. 7 is a graph showing an average relative change in resistance of the present sensor apparatus;

FIG. 8 is a graph showing an initial unloaded resistance of the present sensor apparatus;

FIG. 9 is a graph showing loading pressure and corresponding relative change in resistance of the present sensor apparatus on curved surfaces;

FIG. 10 is a graph showing a pressure response comparison of the present sensor apparatus;

FIG. 11 is an electrical circuit diagram for the present sensor apparatus;

FIGS. 12A and B are software logic flow diagrams used with the present sensor apparatus;

FIGS. 13A-18B show mapping contours of the present sensor apparatus based on relative change in directly measured resistance;

FIG. 19 is a true elevational view showing a sea lamprey attached to the present sensor apparatus;

FIGS. 20-37 are graphs showing mapping contours of the sea lamprey attached to the present sensor apparatus;

FIG. 38 is a diagram of the present sensor apparatus and machine learning-based detection;

FIGS. 39 and 40 are graphs showing postprocessing results on the sea lamprey-on- present sensor apparatus, dataset with a confidence threshold as the variable;

FIG. 41 is an alternate embodiment showing the present sensor apparatus on a robotic gripper;

FIG. 42 is another alternate embodiment showing the present sensor apparatus on a wearable glove; and

FIGS. 43-57 are a series of diagrammatic views showing the manufacturing process of the present sensor apparatus.

### DETAILED DESCRIPTION

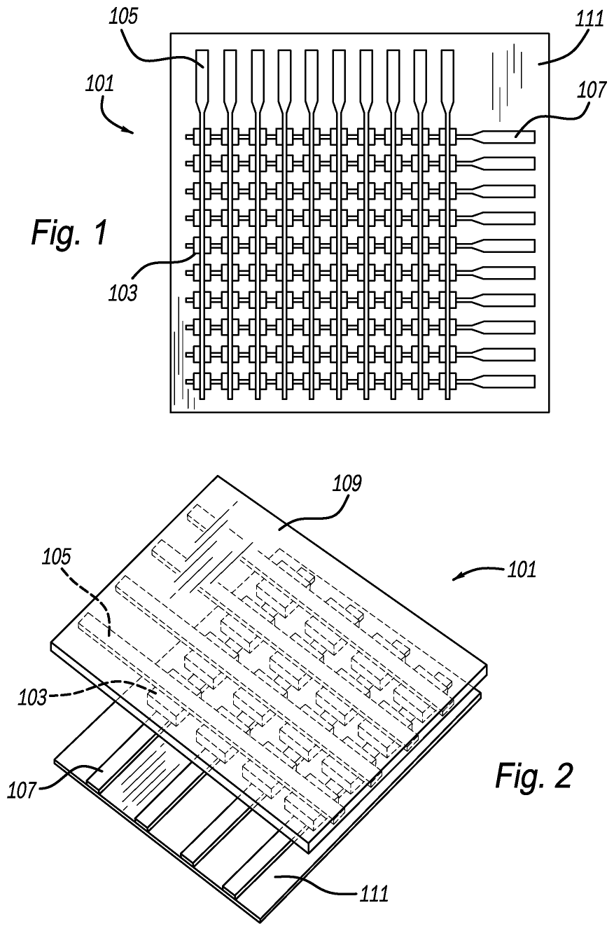

Referring to FIGS. 1-3, a preferred embodiment of the present soft pressure sensor apparatus 101 includes piezoresistive film patches 103 sandwiched between layers of substantially perpendicular electrodes 105 and 107, to create a resistor network circuit with the ability to reconstruct cell resistance from measured two-point resistance. Patches 103 are generally rectangularly shaped pressure sensitive film segments which are a carbon-impregnated polyolefin material exhibiting piezoresistive properties. The piezoresistive film used in the present sensor is Velostat® brand SCS conductive film, 1700 series, preferably having a thickness of about 102 microns. Patches 103 are spaced apart from each other, and there are at least four and more preferably at least sixteen piezoresistive patches arranged in an array of aligned rows and columns.

Furthermore, the two electrode sets 105 and 107 each have multiple elongated, substantially parallel and spaced apart, conductive metal electrode traces 105a-d . . . and 107a-d . . . . There are at least four electrodes in each set and more preferably at least ten in each set. The electrodes of set 105 cross and intersect those of set 107, as viewed in FIG. 1, with piezoresistive patches 103 located at the intersections thereof. The electrodes preferably are copper or an alloy thereof, however, different types of conductive foils can alternately be used.

In a nonlimiting example, each patch is a 6 mm×6 mm segment of the piezoresistive film and the copper tape electrodes are approximately sized 100 mm×3 mm×0.04 mm. The patches are secured within the electrodes by encapsulating polyester tape outer layers 109 and 111, with tape strips 113 and 115 adhering the layers together. More specifically, double-sided acrylic tape strips and one-sided polyester tape outer layers are employed. This creates a flexible, soft and waterproof sensor.

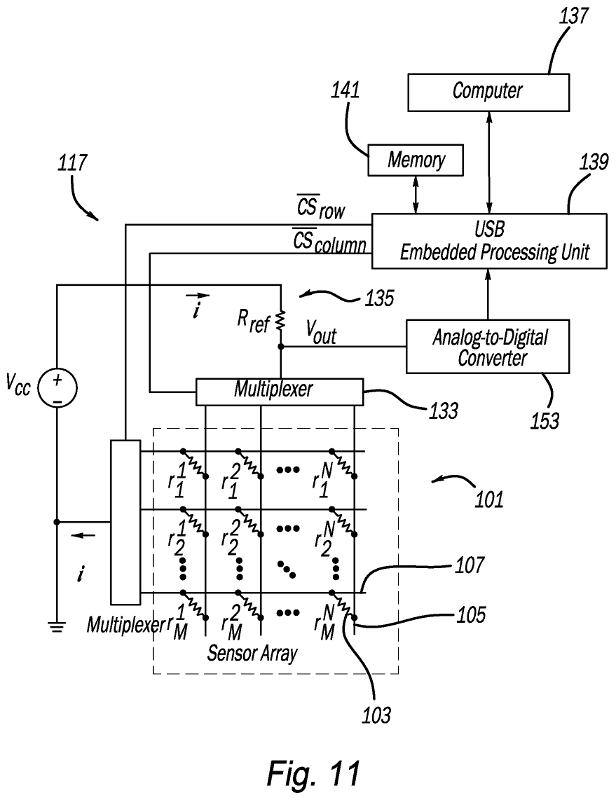

The piezoresistive film matrix and two layers of perpendicular electrodes, create a resistor network in an electrical circuit 117 (see FIG. 11), which introduces a crosstalk issue between adjacent resistors 103; that is, a measured two-point resistance is influenced by all the other resistors in the network. The relation between the cell resistance at any pixel and the apparent resistance between an offset pair of the electrodes (i.e., corresponding column and row) is analytically derived and expressed as an explicit nonlinear forward function from the Laplacian matrix of the cell conductance to the measured two-point resistance matrix. The forward problem from the cell resistance matrix to the measured resistance matrix is relatively straightforward. Nevertheless, the inverse problem is intractable, and no analytical solution has been traditionally available, and if there are modelling errors or measurement noises, a solution could be unbounded.

If the measured two-point resistance is used to characterize the pressure response, the sensing matrix devices of different row and column dimensions will show different amplitudes of changes at the same corresponding pixels under the same pressure, due to the crosstalk, which has been problematic for traditional pressure characterization. Therefore, the present apparatus, including the automated software instructions, reconstructs the cell resistance from the measured two-point resistance. The present apparatus and method address a signal processing challenge arising due to the intrinsic crosstalk issue in a coupled resistor network, as compared with traditional field-effect transistor (“FET”)-pressure sensitive rubber (“PSR”) devices capable of mapping pressure that adopt an active-matrix design and measure individual pixels without crosstalk. It is noteworthy that since the present passive resistive matrix approach is more compact and enables simpler fabrication and measurement than the active-matrix approach, the pressure sensor based on passive matrices is highly beneficial.

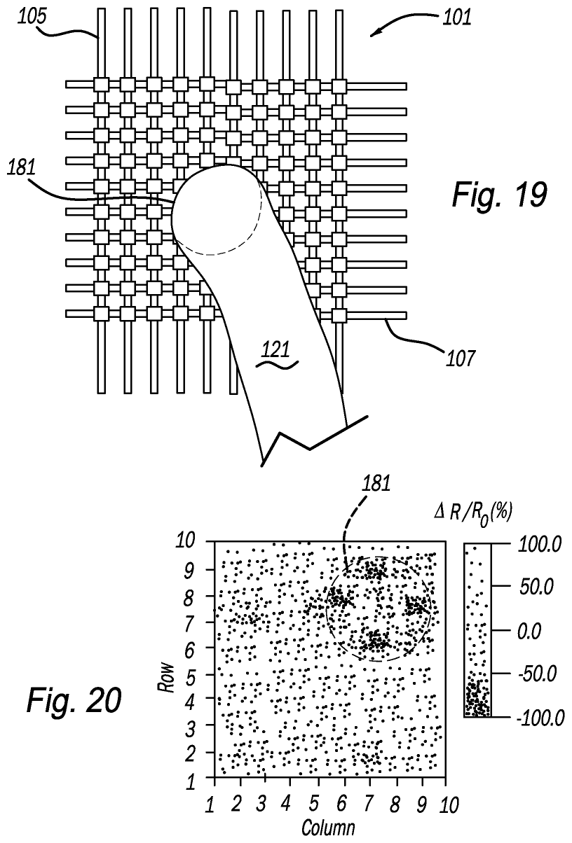

The present soft piezoresistive pressure sensing system is applied to an in-liquid environment where a specimen 121 (see FIG. 19) applies a negative pressure or suction force to the sensor. In a preferred embodiment, specimen 121 is a sea lamprey animal. Advantageously, the present sensor greatly mitigates overall layer delamination concerns for underwater suction scenarios. Moreover, the encapsulated and waterproof sensor is useful submerged within bodies of water and especially well-suited for use in a salt water environment where corrosion is otherwise a concern.

For the cell resistance reconstruction, the present apparatus and method derive the general relationship between the cell resistance and the measured resistance based on Kirchhoff's current law. The present system uses regularized least-squares algorithms and examines multiple choices for the penalty function. Four compound minimization criteria are explored, where a priori terms penalizing: (a) the cell resistance, (b) the relative change in cell resistance, (c) the gradient of cell resistance, and (d) the gradient of relative change in cell resistance, are added to the least-squares term to form cost functions. While such methods, algorithms and software instructions are applied to lamprey detection in the preferred exemplary embodiment, they are also applicable in numerous other soft robotic systems and electronic skin applications, such as foot pressure sensing, haptic interaction, and soft robotic fingers with haptic feedback, as will be later discussed herein.

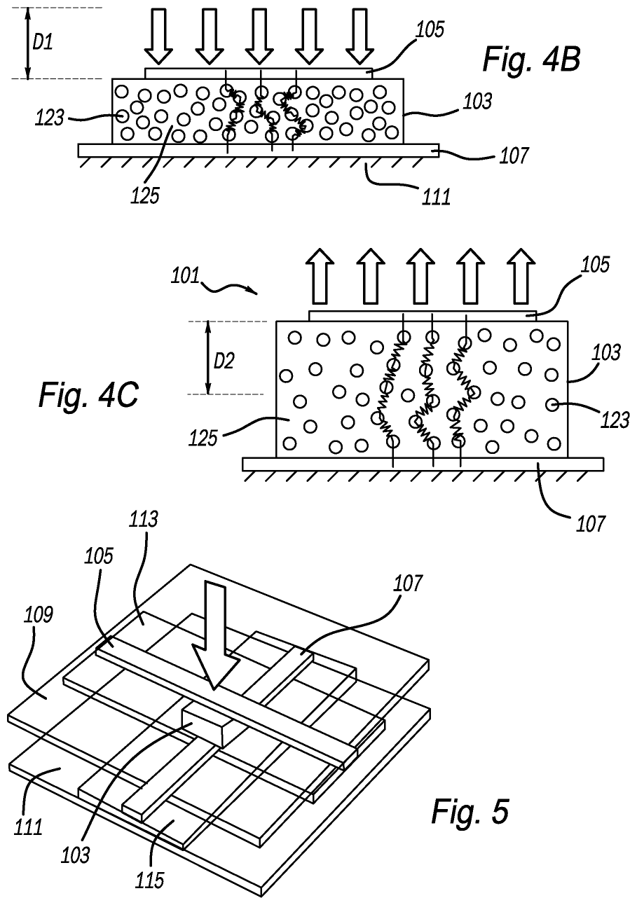

More specifically, each piezoresistive pressure sensor patch 103 is preferably a force-sensitive conductive film of 1700 series, such as from SCS Company. This film is opaque, volume-conductive carbon-impregnated polyolefin, which has a thickness of about 102 μm and a volume resistivity of less than 500Ω·cm. Since conductive carbon nanoparticles 123 are embedded in a non-conductive polyolefin polymer 125, as shown in FIGS. 4A-C, film 103 exhibits a high resistance in an initial state. When the film 103 is under external compressive force or pressure, illustrated by comparing nominal and relaxed FIG. 4A with compressed thickness distance D₁ of FIG. 4B, carbon nanoparticles 123 are closer to each other which results in a lower electrical resistance. The resistance change directly reflects the magnitude of the external compressive pressure, and this property can be used for piezoresistive pressure sensing. FIG. 4C shows negative pressure or suction forces applied to the present sensor 101, which causes expansion of the nanoparticles thereby enlarging the thickness D₂ of this layer and increasing electrical resistance due to the spreading apart of nanoparticles 123.

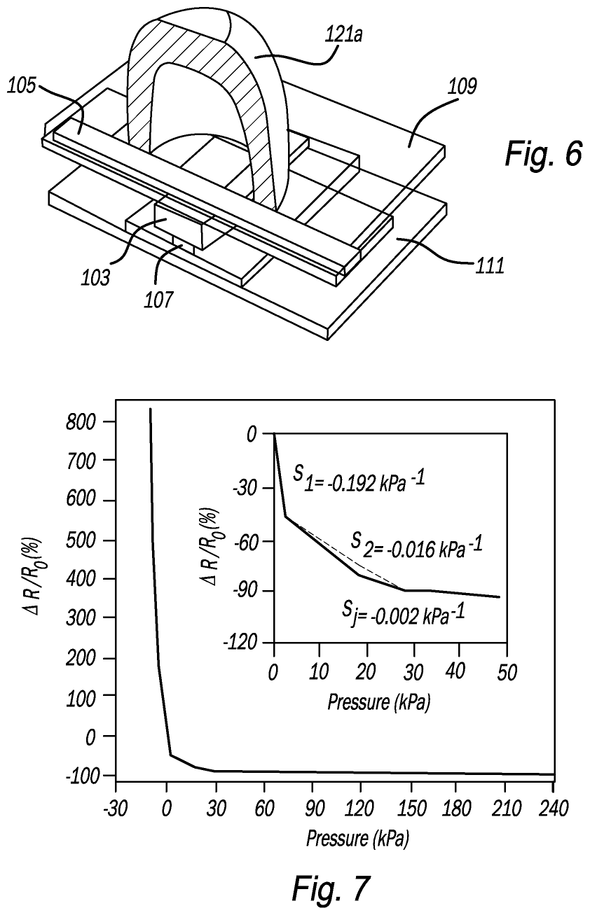

FIGS. 4B and 4C show the soft sensor under a compressive pressure, while FIGS. 4C and 6 show the sensor under suction pressure via a suction cup specimen 121a. Two single-pixel pressure sensors were characterized with different loads and suction pressures, with each pressure tested for three rounds individually. The response results were averaged, and the characterization curve of relative change in measured resistance ΔR/R₀ versus pressure P (−10˜235 kPa) is shown in FIG. 7. When the compressive load reaches 235 kPa, the resistance decreased by 98%. On the other hand, when the suction pressure was set to −10 kPa, the resistance increased by about 654%, likely due to local delamination upon suction, although the delamination has been greatly mitigated by this structure design and fabrication method.

ΔR/R0 decreases linearly with the applied pressure in the low-pressure region. The pressure sensitivity, S=δ(ΔR/R₀)/δP, indicates the local slope in the response curve. The inset of FIG. 7 shows the variation of the sensitivity depending on the applied pressure: an S value of −0.192 kPa⁻¹ between 0 and 2.5 kPa, which reduces to about −0.016 kPa⁻¹ for pressure between 2.5 and 28 kPa. When the pressure is above 28 kPa, the relative change in resistance seems to be largely saturated and not to decrease appreciably with pressure.

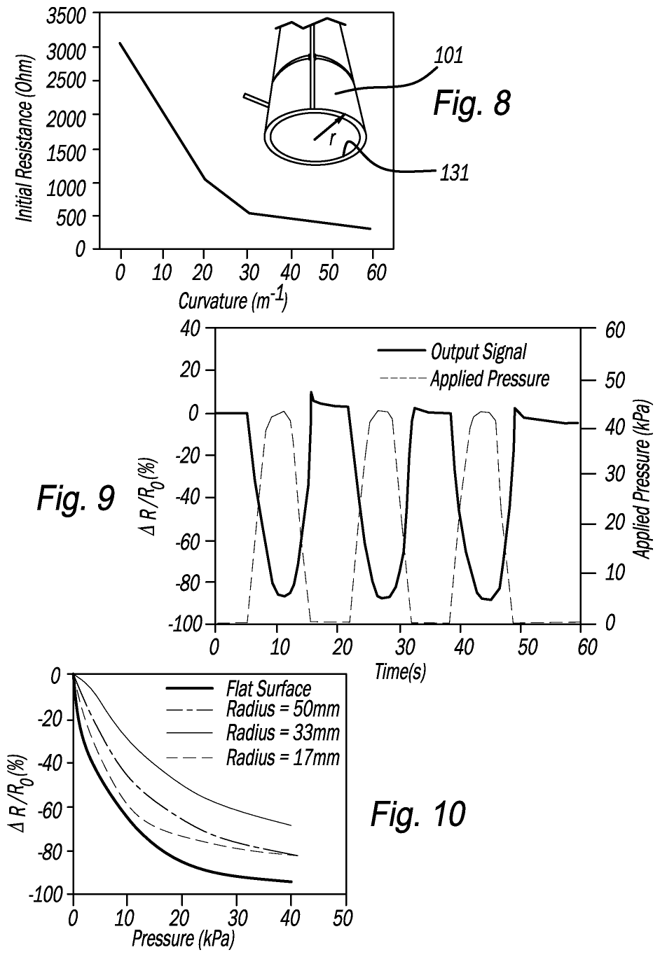

To investigate mechanical flexibility, such as bending deformation of the present soft sensor, a single-pixel sensor's resistance is examined when the sensor device was bent. FIG. 8 shows the resistance of flexible sensor 101 when it was bent and attached onto a curved exterior surface of a cylindrical pipe 131 or tube. The initial (unloaded) resistance was maximized on a flat surface (i.e., zero curvature) with a value about 3.05 kΩ, and then decreased to about 1.03 kΩ, 560Ω, and 350Ω at a curvature of 20 m⁻¹, 30.3 m⁻¹, and 58.8 m⁻¹, respectively, which demonstrates the significant dependence of the initial resistance on the curvature. The reason for this change in the initial resistance is that larger curvature implies higher bending stress in the sensor device, which leads to greater compression between the electrodes and causes a drop in resistance.

To shed light on the pressure response of the sensor device on curved surfaces, time-resolved measurements were further conducted. A program-customized syringe pump (such as a Legato 110 model from KD Scientific, Inc.) was used to apply an external pressure of up to about 40 kPa onto the bent sensor (providing an effective pressure contact area of 3 mm×3 mm from the copper electrodes) attached on the pipe. The pressure was calculated based on the measured contact force through a load cell (such as a GS0-100 model from Transducer Techniques, LLC). Three cycles of loading and unloading processes were repeated with a period of approximately 18 seconds. Accordingly, FIG. 9 shows relative change in the resistance, ΔR/R₀, of the sensor for the case with curvature radius of 50 mm, where ΔR=R−R₀, R₀ is the initial resistance at the bending status, and R is the new resistance under the external pressure. During these three rounds of tests, the sensor was repeatable and robust. Furthermore, for different curvature radii (50 mm, 33 mm, and 17 mm), the pressure response curves of the same sensor device were plotted in FIG. 10 for comparison. Clearly, the relative change in resistance exhibits maximal values at 40 kPa, achieving −94% when the sensor device is on the flat substrate, then it reduces to −82%, −69%, and −81% on the curved surface with a curvature radius of 50 mm, 33 mm and 17 mm, respectively. The maximum (absolute) change in the resistance output for these curved cases drops since the initial resistance of the sensor under bending on the curved surfaces is much smaller than that on a flat substrate surface.

Modeling of the 2D resistor network will now be discussed. For the M-by-N 2D resistor network of electrical circuit 117 shown in FIG. 11, two multiplexers 133 (such as those from SparkFun, model CD74HC4067) are used to select the column and the row to form the circuit for a given “pixel.” By using a voltage divider 135 with a reference resistor R_{ref}, the resistance measurement Rⱼ^{k} between the selected j th row and k th column can be calculated as:

$${R}_{j}^{k} = \frac{{V}_{out}}{{V}_{cc} - {V}_{out}} \times {R}_{ref} \qquad ( 1 )$$

Note, however, that the measured two-point resistance Rⱼ^{k} is not equal to the cell resistance rⱼ^{k} at that pixel (j, k) due to crosstalk; in particular, Rⱼ^{k} is theoretically smaller than rⱼ^{k} since it is a parallel connection between rⱼ^{k} and a network of resistors between row j and column k. For instance, if row 1 and column 1 are selected by the multiplexers, the current would be injected from node V¹ to V₁ through cell resistor r₁¹ and other branches; for example, the current could flow from node V¹ to V₂ through r₁², then to V² through r₂², and finally back to V₁ through r₂¹. With larger dimensions of the network, there will be more circuit loops involved between the selected row and column.

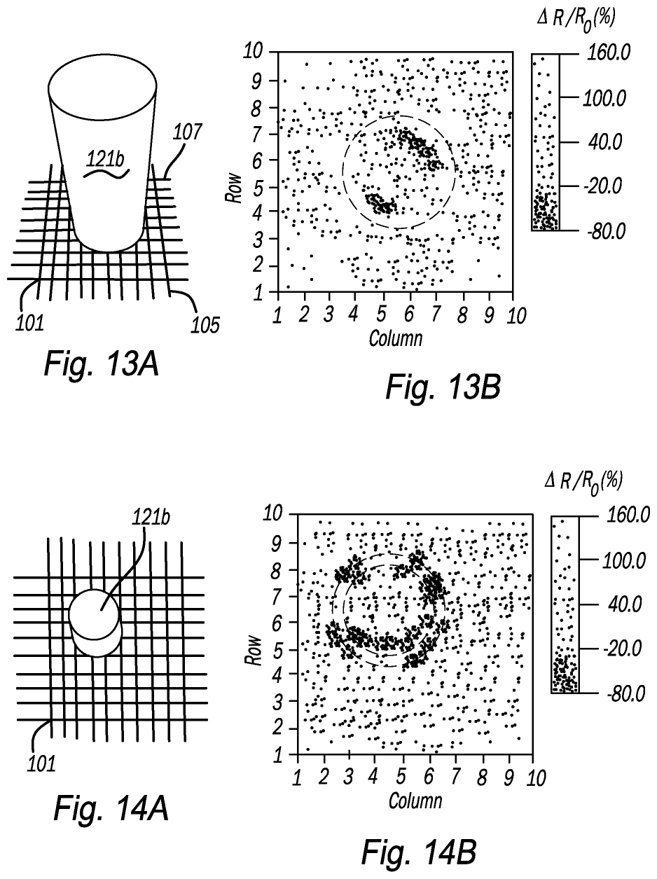

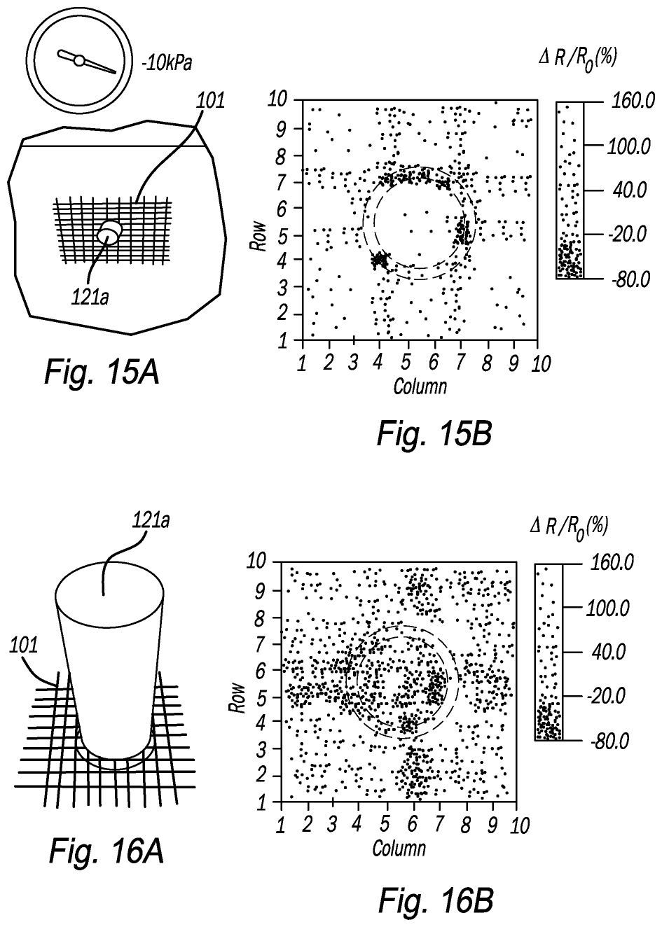

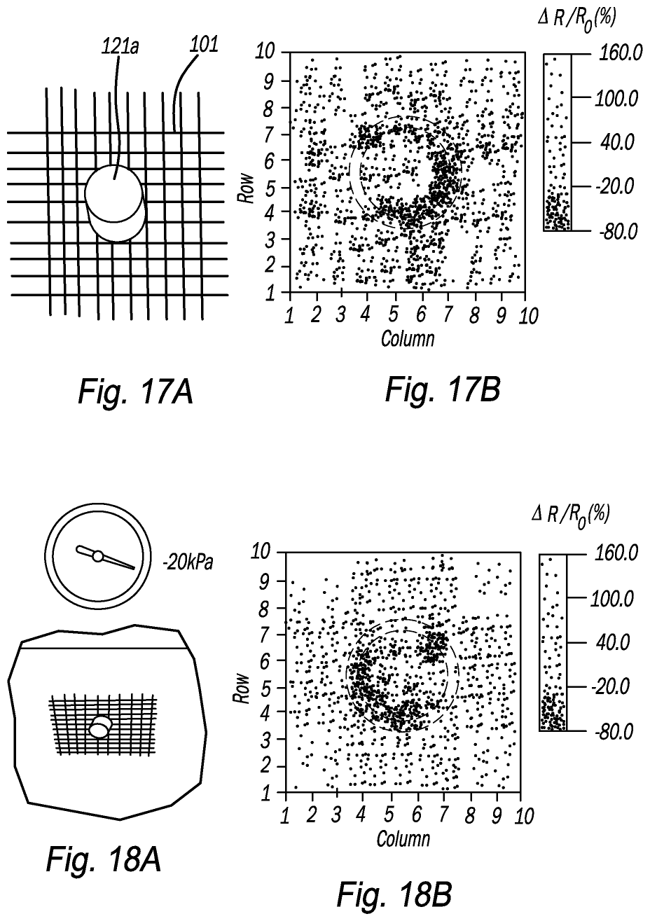

Mapping contours based on measured resistance can be observed in FIGS. 13A-18B. With the fabricated 10×10 soft pressure sensor array, using the two 16-channel multiplexers and a 1 kΩ reference resistor, the two-point resistance between each row and each column was measured directly through the voltage divider circuit. Mapping contours of the soft pressure sensing matrix based on relative change in directly measured resistance with the following experimental conditions: (a) in FIGS. 13A and B, a φ40 mm (φ represents diameter), 680 g aluminum rod specimen 121b was loaded on sensing matrix 101; (b) in FIGS. 14A and B, a φ27 mm×φ35 mm×5 mm 3D printed ring part under a 850 g aluminum rod 121b was loaded on sensing matrix 101; (c) in FIGS. 15A and B, −10 kPa, and in FIGS. 16A and B, −20 kPa, respectively, negative pressure was applied on sensing matrix 101 via a φ27 mm×φ35 mm PDMS suction cup 121a in air; and (d) in FIGS. 17A and B, −10 kPa and in FIGS. 18A and B, −20 kPa, respectively, negative pressure was applied on the sensing matrix via the same suction cup 121a under water, where the top row of copper tape electrode of the soft pressure sensor 101 was about 7 cm lower than the water level.

The series of experiments were conducted on the 10×10 soft pressure sensor array 101, such as the loading of aluminum rod 121b (FIGS. 13A and B), the loading of weight through a 3D-printed ring part (FIGS. 14A and B), the suction and attachment of a suction cup 121a under different negative pressures in air (FIGS. 15A-16B), and also the suction cup experiments with the soft pressure sensor matrix under water in a tank (FIGS. 17A-18B). All the mapping contours of relative change in directly measured resistance are shown side-by-side with the corresponding experimental picture, which demonstrates that the present soft pressure sensor successfully detects multiple kinds of pressure patterns.

It is of interest to find the relation between the cell resistance values rⱼ^{k} and the measured resistance values Rⱼ^{k}, which is needed in the reconstruction algorithms. To derive this relationship, nodal analysis or the branch current method is used. In nodal analysis, one equation is given at each node, requiring that the branch currents incident at a node must sum to zero based on the Kirchhoff's current law (KCL). Once the branch currents are expressed in terms of the circuit node voltages, the conductance between any two nodes can be discovered.

In general, for the M×N resistor network in FIG. 11, if the voltage source is replaced with a current source, M voltage nodes for the rows and N voltage nodes for the columns can be studied; correspondingly, (M+N) current sources (including possibly zero current) is present at these (M+N) nodes. According to KCL, the node-voltage equations is written in a matrix form as:

$$\begin{matrix}LV = I & ( 2 ) \\ L = [ \begin{matrix}{C}_{1 , 1} & ⋯ & {C}_{1 , M} & {C}_{1}^{1} & ⋯ & {C}_{1}^{N} \\ {C}_{2 , 1} & ⋯ & {C}_{2 , M} & {C}_{2}^{1} & ⋯ & {C}_{2}^{N} \\ ⋮ & ⋱ & ⋮ & ⋮ & ⋱ & ⋮ \\ {C}_{M , 1} & ⋯ & {C}_{M , M} & {C}_{M}^{1} & ⋯ & {C}_{M}^{N} \\ {C}_{1}^{1} & ⋯ & {C}_{M}^{1} & {C}^{1 , 1} & ⋯ & {C}^{1 , N} \\ {C}_{1}^{2} & ⋯ & {C}_{M}^{2} & {C}^{2 , 1} & ⋯ & {C}^{2 , N} \\ ⋮ & ⋱ & ⋮ & ⋮ & ⋱ & ⋮ \\ {C}_{1}^{N} & ⋯ & {C}_{M}^{N} & {C}^{N , 1} & ⋯ & {C}^{N , N}\end{matrix} ] & ( 3 ) \\ and V = [ \begin{matrix}{V}_{1} \\ {V}_{2} \\ ⋮ \\ {V}_{M} \\ {V}^{1} \\ {V}^{2} \\ ⋮ \\ {V}^{N}\end{matrix} ] , I = [ \begin{matrix}{I}_{1} \\ {I}_{2} \\ ⋮ \\ {I}_{M} \\ {I}^{1} \\ {I}^{2} \\ ⋮ \\ {I}^{N}\end{matrix} ] & ( 4 )\end{matrix}$$

where, L_{(M+N)×(M+N)} is the Laplacian matrix of the M×N resistor network, V is the voltage pattern, and I is the current pattern. C_{j,j} is the sum of the conductance between the row node Vⱼ and any other node; C^{k,k} is the sum of the conductance between the column node V^{k} and any other node; Cⱼ^{k} is the negative of the sum of the conductance between the row node Vⱼ and the column node V^{k}; C_{j,h}=0, where 1≤j≤h≤M, is the conductance between row j and row h; and C^{k,l}=0, where 1≤k≤I≤N, is the conductance between column k and column /, since the rows are not connected directly with each other and neither are the columns. L is singular since the sum of all rows of L is equal to 0, which means these (M+N) equations are not independent. To remove the redundant equation, the first-row node is chosen as the ground (zero voltage reference), V₁=0, and the first equation in Equation (2) is eliminated. Then a new cofactor matrix with a reduced dimension of (M+N−1)×(M+N−1) along with (M+N−1) independent equations is obtained from the Laplacian matrix, and Equation (2) is reduced to

$$\begin{matrix}ℂ𝕍 = 𝕀 \\ where , & ( 5 ) \\ \begin{matrix}ℂ = [ \begin{matrix}{C}_{2 , 2} & ⋯ & {C}_{2 , M} & {C}_{2}^{1} & ⋯ & {C}_{2}^{N} \\ {C}_{3 , 2} & ⋯ & {C}_{3 , M} & {C}_{3}^{1} & ⋯ & {C}_{3}^{N} \\ ⋮ & ⋱ & ⋮ & ⋮ & ⋱ & ⋮ \\ {C}_{M , 2} & ⋯ & {C}_{M , M} & {C}_{M}^{1} & ⋯ & {C}_{M}^{N} \\ {C}_{2}^{1} & ⋯ & {C}_{M}^{1} & {C}^{1 , 1} & ⋯ & {C}^{1 , N} \\ {C}_{2}^{2} & ⋯ & {C}_{M}^{2} & {C}^{2 , 1} & ⋯ & {C}^{2 , N} \\ ⋮ & ⋱ & ⋮ & ⋮ & ⋱ & ⋮ \\ {C}_{2}^{N} & ⋯ & {C}_{M}^{N} & {C}^{N , 1} & ⋯ & {C}^{N , N}\end{matrix} ] \\ = [ \begin{matrix}{\sum }_{j = 1}^{N} {g}_{2}^{j} & 0 & 0 & & & \\ & ⋯ & 0 & - {g}_{2}^{1} & ⋯ & - {g}_{2}^{N} \\ 0 & & & ⋮ & ⋯ & ⋮ \\ ⋮ & ⋱ & ⋮ & ⋮ & ⋱ & ⋮ \\ 0 & ⋯ & {\sum }_{j = 1}^{N} {g}_{M}^{j} & - {g}_{M}^{1} & ⋯ & - {g}_{M}^{N} \\ - {g}_{2}^{1} & ⋯ & - {g}_{M}^{1} & {\sum }_{k = 1}^{M} {g}_{k}^{1} & 0 & 0 \\ & & & & ⋯ & 0 \\ ⋮ & ⋱ & ⋮ & ⋮ & ⋱ & ⋮ \\ - {g}_{2}^{N} & ⋯ & - {g}_{M}^{N} & 0 & 0 & {\sum }_{k = 1}^{M} {g}_{k}^{N}\end{matrix} ]\end{matrix} & ( 6 ) \\ and V = [ \begin{matrix}{V}_{2} \\ {V}_{3} \\ ⋮ \\ {V}_{M} \\ {V}^{1} \\ {V}^{2} \\ ⋮ \\ {V}^{N}\end{matrix} ] , I = [ \begin{matrix}{I}_{2} \\ {I}_{3} \\ ⋮ \\ {I}_{M} \\ {I}^{1} \\ {I}^{2} \\ ⋮ \\ {I}^{N}\end{matrix} ] & ( 7 )\end{matrix}$$

Here, [symbol] is non-singular, and

$${g}_{j}^{k} = \frac{1}{{r}_{j}^{k}}$$

is the conductance or the cell resistor rⱼ^{k}. One can then obtain

[symbol]

= [symbol] ⁻¹ [symbol] (8)

Accordingly, if all cell resistances {rⱼ^{k}} are known, the co-factor matrix [symbol] is available and so is its inverse. The current pattern [symbol] is specified in this way: for the current loop between the studied row node Vⱼ and the column node V^{k}, since the current source noted as i is injected into the column node V^{k}, the corresponding current element I^{k}=i; and since the current is withdrawn from the row node Vⱼ to the ground, the corresponding current element Iⱼ=−i; and all the other row and column nodes have zero current sources. For instance, if the column node V¹ (flow in) and the row node V₂ (flow out) are the two points to measure the resistance, the current pattern [symbol] =[I₂I₃ . . . I_{M}I₁I₂ . . . I^{N}]^{T}=[−i 0 . . . 0 i 0 . . . 0]^{T}. If V¹ (flow in) and V₁ (flow out) are the two points to measure the resistance, then the current pattern [symbol] =[0 0 . . . 0 i 0 . . . 0]^{T}.

Based on Equation (8), the voltages at all the nodes are then expressed in terms of the current i, and, thus, according to Ohm's Law, the two-point resistance Rⱼ^{k} between the studied row Vⱼ and column V^{k} is solved as:

$${R}_{j}^{k} = \frac{{V}^{k} - {V}_{j}}{i} \qquad ( 9 )$$

With Equations (5)-(8), there exists an implicit function ƒ(·) mapping from the cell resistance matrix r=[rⱼ^{k}] to the measured two-point resistance matrix R=[Rⱼ^{k}]:

R=ƒ(r) (10)

It should be noted that, in reality, the measured two-point resistance matrix, Rₘ, is not exactly equal to R as calculated in Equation (10), due to modeling errors and measurement noises. Although Equation (5) is linear in the cell conductance, the mapping from the cell conductance to the cell resistance is reciprocal and nonlinear. And since C_{j,j} and C^{k,k} are the sums of the conductance connected to the same row or column node, respectively, Equation (10) for the forward problem is nonlinear and implicit. The present algorithms for solving the inverse problem are subsequently discussed hereinafter.

Cell resistance reconstruction is performed by least-squares regularization. The forward problem from the cell resistance matrix r to the measured resistance matrix R is relatively straightforward. However, the inverse problem, which is reconstructing the cell resistance r based on the measured two-point resistance Rₘ, is much harder and does not admit an analytical solution. Consequently, numerical methods have to be used. Hence, a basic least-squares algorithm is first presented and then, four regularized least-squares algorithms with different regularization functions that aim to enhance the robustness of the reconstruction in the presence of measurement noises and modeling errors.

Least-squares minimization (“LSM”) is utilized. The inverse problem for the resistive network can be formulated as an optimization problem where the cost function to be minimized is the sum of squared residuals between the measured two-point resistances Rₘ and the calculated R based on Equation (10), with the requirement that the cell resistance is larger than or equal to the measured resistance:

$$\begin{matrix}\hat{r} = arg {min}_{r} {\sum }_{j = 1 , k = 1}^{M , N} {‖ {f ( r )}_{j}^{k} - {( {R}_{m} )}_{j}^{k} ‖}^{2} & ( 11 ) \\ s . t . {r}_{j}^{k} \geq {( {R}_{m} )}_{j}^{k} for all j and k & ( 12 )\end{matrix}$$

where rⱼ^{k} is the cell resistance element at the pixel (j, k) while (Rₘ)ⱼ^{k} is the corresponding measured two-point resistance.

This least-squares problem is solved in MATLAB via the nonlinear least-square solver “Isqnonlin”, which starts at an initial guess r₀≥Rₘ (where “≥” holds true element-wise). The default algorithm for this solver is the trust-region-reflective algorithm based on the interior-reflective Newton method, which approximates the objective function by the first two terms of the Taylor-series approximation, restricts the trust-region subproblem to a two-dimensional subspace, and chooses the solver step to force global convergence via the gradient descent while achieving fast local convergence via the Newton step if it exists.

Furthermore, the resistor network inverse problem and, in particular, the numerical inverse solution depends sensitively on the input data and, thus, its performance, is susceptible to measurement noises and modeling uncertainties. In order to reconstruct the cell resistance robustly and to give preference to particular solutions with desirable properties, the Tikhonov regularization technique is exploited, where a regularization term is included in the least squares minimization. One of the typical a priori regularization terms is the L₂ regularization, λ∥r∥₂², which is the sum of the squares of all elements from the inverse solution with a penalty weight λ that penalizes large cell resistance values:

$$\begin{matrix}\hat{r} = arg {min}_{r} {\sum }_{j = 1 , k = 1}^{M , N} \{ {‖ {f ( r )}_{j}^{k} - {( {R}_{m} )}_{j}^{k} ‖}^{2} + λ {‖ {r}_{j}^{k} ‖}^{2} \} & ( 13 ) \\ s . t . {r}_{j}^{k} \geq {( {R}_{m} )}_{j}^{k} for all j and k . & ( 14 )\end{matrix}$$

where λ≥0 is the regularization (or penalty) parameter, which determines the trade-off between the modeling discrepancy term and the regularization term. The regularization method in Equation (13) accommodates simultaneously the norm of the residual [ƒ(r)−Rₘ] and the norm of the approximate solution r, enforcing the a priori knowledge on solving the cell resistance, and improving the smoothness of the solution.

Different sensor pixels might have quite different cell resistances in the initial relaxed state before a pressure is applied, due to, for example, imperfect fabrication processes. So, an alternative regularization function would be the relative change in the cell resistance values, instead of these values themselves:

$$[ {\hat{r}}_{0} {\hat{r}}_{1} ] = arg {min}_{{r}_{0} {r}_{1}} {\sum }_{j = 1 , k = 1}^{M , N} \{ {‖ {f ( {r}_{0} )}_{j}^{k} - {( {R}_{m 0} )}_{j}^{k} ‖}^{2} + {‖ {f ( {r}_{1} )}_{j}^{k} - {( {R}_{m 1} )}_{j}^{k} ‖}^{2} + λ {‖ \frac{{( {r}_{1} )}_{j}^{k} - {( {r}_{0} )}_{j}^{k}}{{( {r}_{0} )}_{j}^{k}} \times 100 ‖}^{2} \} \qquad ( 15 )$$

$$s . t . {( {r}_{0} )}_{j}^{k} \geq {( {R}_{m 0} )}_{j}^{k} and {( {r}_{1} )}_{j}^{k} \geq {( {R}_{m 1} )}_{j}^{k} for all j and k . \qquad ( 16 )$$

where (r₀)ⱼ^{k} and (Rₘ₀)ⱼ^{k} are the cell resistance and the measured two-point resistance corresponding to the first group of measurements (e.g., prior to the application of the external pressure), while (r₁)ⱼ^{k} and (Rₘ₁)ⱼ^{k} are those corresponding to the second group of measurements (e.g., after the pressure is applied). The data 100 in the equation denotes the percentage calculation in order to get the relative change in cell resistance.

The relative change in cell resistance is evaluated based on two consecutive cell resistance matrices. For the initialization step of this regularization and in order to calculate the relative change in cell resistance (in percentage), two groups of measured resistance Rₘ₀ and Rₘ₁ are fed into Equation (15) at the beginning. Once the first two sets of cell resistance solutions r₀ and r₁ are solved jointly, r₀, Rₘ₀, and Rₘ₁ are not further used while r₁ is taken as the known new r₀′. The next set of measured resistance Rₘ₂ is then used as the new Rₘ₁′, and Equation (15) is replaced with a new regularization in order to find the corresponding solution r₁′ for the new measurements:

$${\hat{r}}_{1}^{′} = arg {min}_{{r}_{1}^{′}} {\sum }_{j = 1 , k = 1}^{M , N} \{ {‖ {f ( {r}_{1}^{′} )}_{j}^{k} - {( {R}_{m 1}^{′} )}_{j}^{k} ‖}^{2} + λ {‖ \frac{{( {r}_{1}^{′} )}_{j}^{k} - {( {r}_{0}^{′} )}_{j}^{k}}{{( {r}_{0}^{′} )}_{j}^{k}} \times 100 ‖}^{2} \} \qquad ( 17 )$$

$$s . t . {( {r}_{1}^{′} )}_{j}^{k} \geq {( {R}_{m 1}^{′} )}_{j}^{k} for all j and k . \qquad ( 18 )$$

The reconstruction will be initialized first and then be updated iteratively for the following steps.

Using the cell resistance gradient as the regularization term to minimize spikes in the mapping contours is captured as follows:

$$\begin{matrix}\hat{r} = arg {min}_{r} {\sum }_{j = 1 , k = 1}^{M , N} \{ {‖ {f ( r )}_{j}^{k} - {( {R}_{m} )}_{j}^{k} ‖}^{2} + λ {‖ ∇ {r}_{j}^{k} ‖}^{2} \} & ( 19 ) \\ s . t . {r}_{j}^{k} \geq {( {R}_{m} )}_{j}^{k} for all j and k . & ( 20 )\end{matrix}$$

The gradient can be calculated differently according to the location of the pixel. If the pixel is in the interior of the sensing matrix, the gradient components are approximated by the central difference between the neighboring pixels. But if the pixel is on the boundary, the appropriate gradient components are calculated with single-sided differences.

Next, regularization based on the gradient of the relative change in cell resistance is considered.

$$[ {\hat{r}}_{0} {\hat{r}}_{1} ] = arg {min}_{{r}_{0} {r}_{1}} {\sum }_{j = 1 , k = 1}^{M , N} \{ {‖ {f ( {r}_{0} )}_{j}^{k} - {( {R}_{m 0} )}_{j}^{k} ‖}^{2} + {‖ {f ( {r}_{1} )}_{j}^{k} - {( {R}_{m 1} )}_{j}^{k} ‖}^{2} + λ {‖ ∇ ( \frac{{( {r}_{1} )}_{j}^{k} - {( {r}_{0} )}_{j}^{k}}{{( {r}_{0} )}_{j}^{k}} \times 100 ) ‖}^{2} \} \qquad ( 21 )$$

$$s . t . {( {r}_{0} )}_{j}^{k} \geq {( {R}_{m 0} )}_{j}^{k} and {( {r}_{1} )}_{j}^{k} \geq {( {R}_{m 1} )}_{j}^{k} for all j and k . \qquad ( 22 )$$

where two consecutive sets of measured resistances Rₘ₀ and Rₘ₁ are required for initialization at the beginning, and the gradient of the relative change in cell resistance can be calculated accordingly. The updating rule of this algorithm is similar to that in the reconstruction method LSR-ΔCR: first, solve r₀ and r₁ jointly; then, take r₁ as the known new r₀′; and next, take a third set of resistance measurement as the new Rₘ₁′, and the corresponding new cell resistance r₁′ is generated from the following regularization:

$${\hat{r}}_{1}^{′} = arg {min}_{{r}_{1}^{′}} {\sum }_{j = 1 , k = 1}^{M , N} \{ {‖ {f ( {r}_{1}^{′} )}_{j}^{k} - {( {R}_{m 1}^{′} )}_{j}^{k} ‖}^{2} + λ {‖ ∇ ( \frac{{( {r}_{1}^{′} )}_{j}^{k} - {( {r}_{0}^{′} )}_{j}^{k}}{{( {r}_{0}^{′} )}_{j}^{k}} \times 100 ) ‖}^{2} \} \qquad ( 23 )$$

$$s . t . {( {r}_{1}^{′} )}_{j}^{k} \geq {( {R}_{m 1}^{′} )}_{j}^{k} for all j and k . \qquad ( 24 )$$

The reconstruction is updated iteratively with the new measurements coming in, using the latest measurement as Rₘ₁ and using the previous solution as r₀ in order to guarantee the solving process to be consecutive and consistent.

To summarize, several regularized least-squares algorithms are considered for reconstructing the cell resistance from the measured two-point resistance in order to characterize the pressure response (relative change in cell resistance vs. pressure):
least-squares minimization algorithm to find the optimal solution of cell resistance by minimizing the sum of the squared residuals between the measured two-point resistance and the calculated two-point resistance;
least-squares regularization on cell resistance;
least-squares regularization on relative change in cell resistance;
least-squares regularization on gradient of cell resistance; and/or
least-squares regularization on gradient of relative change in cell resistance.

The current machine learning algorithm is based on mapping contour images as input, which are plotted from the relative change in measured resistance. As an alternative, a data-based method is employed that directly uses the data matrices of relative change in measured resistance as the input and construct the machine learning neural networks using multilayer perceptron (“MLP”). The output from the MLP networks can still be the class of the contact pattern and the location and area of the contact.

The current machine learning algorithm uses object detection architecture and models to predict the class, confidence, and bounding box of the contact for each individual frame of the mapping contour images, and then use a designed confidence filter to output the predicted information. As an alternative, the machine learning algorithm can use recurrent neural networks (“RNNs”, such as a long short-term memory (“LSTM”) model) to study the time sequence data of the output class, confidence, and bounding box coordinates of the predicted contact patterns in all frames of mapping contour images, which serves as an additional advanced postprocessing unit after the CNNs to look at the historical information.

The current algorithm has learned from the measured two-point resistance, which means the measured resistance between a selected row and a selected column of the sensor array. But due to the coupling of the sensor array, the present algorithms are used to reconstruct each cell resistance from these measured two-point resistance, and then use machine learning models to learn features from the reconstructed cell resistance.

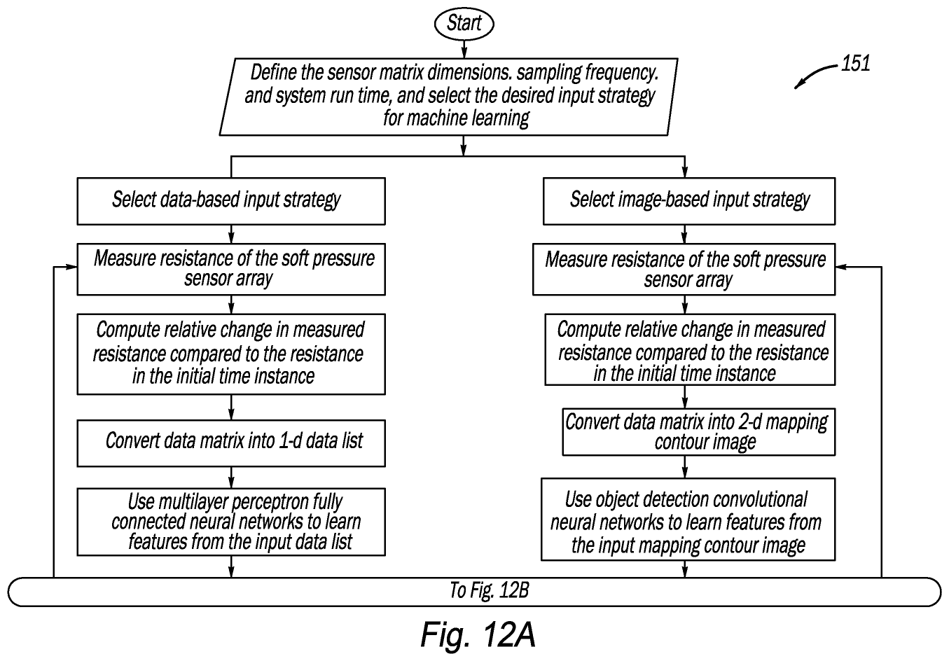

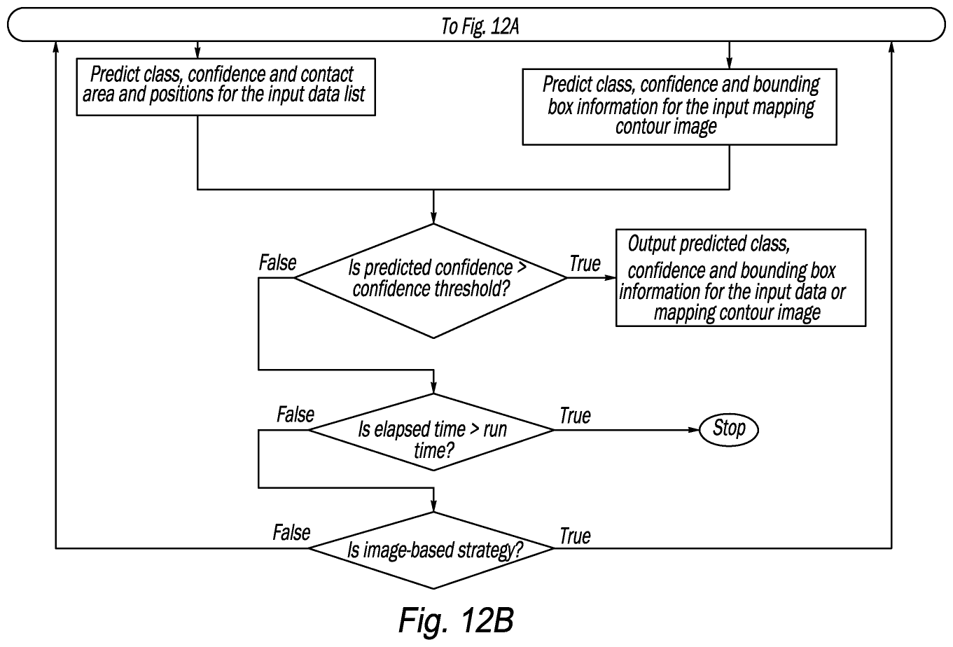

Referring to FIGS. 11 and 12A-B, the present sensor apparatus further includes a programmable computer controller 137 includes a microprocessor or processing unit 139, memory 141, an input device such as keyboard, an output device such as a display screen, and electrical circuit 117 coupling the computer controller to the sensor 101. Programmable computer software instructions 151 are stored in the non-transient memory and operated in the microprocessor. One or more of the algorithms discussed herein and the method steps disclosed herein are incorporated into the software instructions.

The computer will first upload a measurement program to the embedded processing unit via a USB cable. Then the embedded processing unit will send the command to the row multiplexer and the column multiplexer via digital output pins C̅S̅_{row} and C̅S̅_{column} in order to decide which row and which column would be selected for the measurement. In this way, the entire circuit formed by all the sensors at each pixel between the selected row and the selected column constructs a voltage divider circuit with the reference resistor R_{ref}.

The whole circuit in the sensor system is provided with a voltage supply V_{cc}, thus, the nodal voltage Vₒᵤₜ between the reference resistor and the column multiplexer is measured by an analog-to-digital converter 153. Thereafter, the measured voltage Vₒᵤₜ is automatically processed in the embedded processing unit to calculate the two-point resistance R_{M} of the sensor array between the selected row and column. By selecting different rows and different columns through the multiplexers, all the two-point resistance can be measured.

The entire two-point measured resistance matrix is stored in the memory and used to automatically calculate the relative change between the current time instance and the initial time instance. Finally, all the saved data is automatically sent to the computer for storage in a spreadsheet in a hard drive or the like, and/or output displayed.

A contact pattern detection algorithm for the cell resistance reconstruction method is used in the software and controller in a real-time, feedback looped manner. The contact pattern detection algorithm includes at least the following three parts:
converting measured resistance matrix to mapping contour images;
detecting the position and different contact patterns by object detection convolutional neural networks; and
correcting the detection result with a confidence filter.

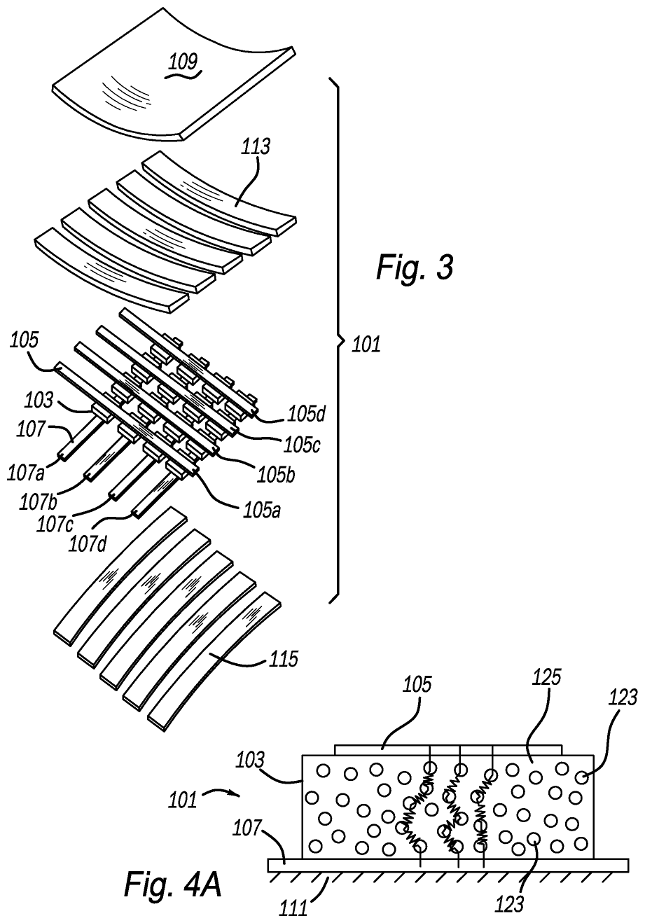

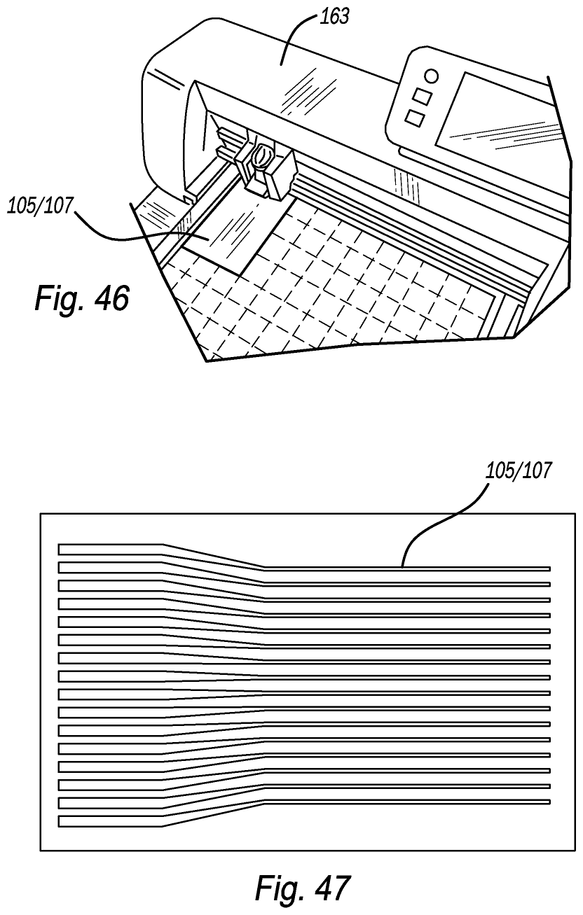

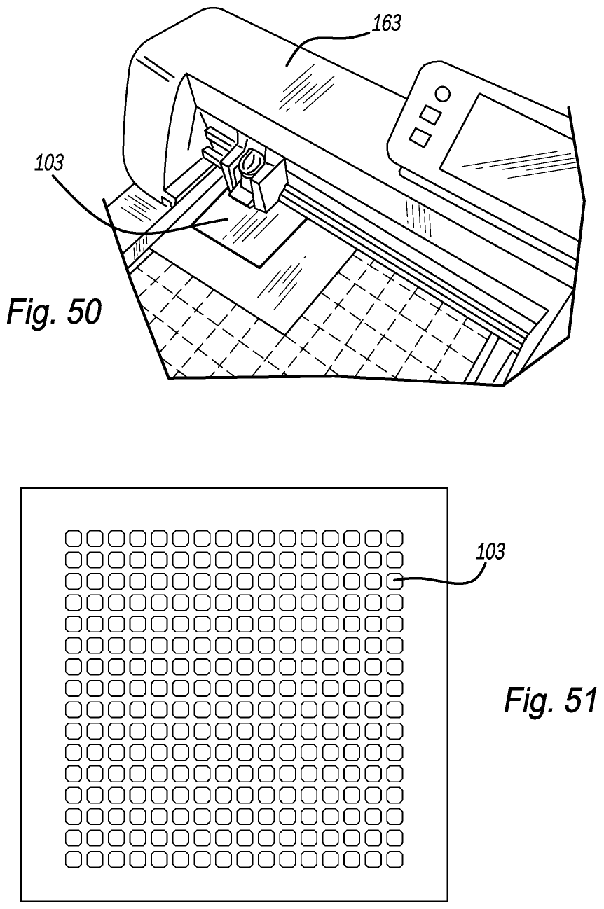

The manufacturing process will now be discussed hereinafter with reference to FIGS. 3 and 43-57. The fabrication process for an exemplary and nonlimiting 10×10 pressure-sensing matrix with a sensing area of 10×10 cm² is as follows. First with reference to FIG. 43, multiple elongated strips of 15 cm×3 mm×0.04 mm (length×width×thickness) copper foil tape traces 107 and multiple elongated pieces of 15 cm×6.3 mm×0.04 mm (length×width×thickness) double-sided acrylic tape 115 are adhered side by side in an alternating manner onto a 300 mm×300 mm×3 mm acrylic plate or outer layer 111 (see FIG. 2); each copper tape has two double-sided tapes bordering on both sides. Then the conductive piezoresistive film is cut into approximately one hundred pieces of square patches 103 (each measuring 6 mm×6 mm), which are subsequently uniformly placed on the copper tape pieces as individual piezoresistive sensors. Here, the copper tape traces act as the column electrodes with the double-sided acrylic tape pieces serving two purposes: filling the space between the copper tape traces (thus making the entire bottom layer flat), and fixing the edges of the conductive film patches (which is why the each patch is wider than the adjacent copper tape). The shiny and non-adhesive surfaces of all the copper tape traces are outwardly exposed in order to contact the conductive film patches since the adhesive side of the copper tape is not prominently conductive.

Similarly, additional strips of copper foil tape traces 105 and additional pieces of double-sided acrylic tape 113 are attached onto the adhesive side of a 10 cm×20 cm polyester tape, which serve as outer top layer 109 of the pressure sensing panel. Then, top outer layer 109 is rotated by 90° and put upside down to attach onto bottom outer layer 111, with conductive film patches 103 between the top and bottom layers of copper tape electrodes 115 and 117, respectively. These two layers of copper electrodes function as the address lines of the sensor apparatus 101. The sandwich assembly is then carefully pressed together to form a stable bonding around each pixel between the adhesive layers. After that, each copper tape is connected with a jumper wire, metal stamping or printed circuit board connector, by soldering, crimping or the like, as the circuit extension for measurements. Moreover, to deploy the pressure sensing panel underwater, waterproof encapsulation by polydimethylsiloxane (PDMS, with a 10:1 wt. % mixing ratio of PDMS base, and a curing agent) is achieved around the sensing assembly, where the edges of the 3M VHB 4905 double-sided tape layers are used to form a mold for the PDMS liquid before curing.

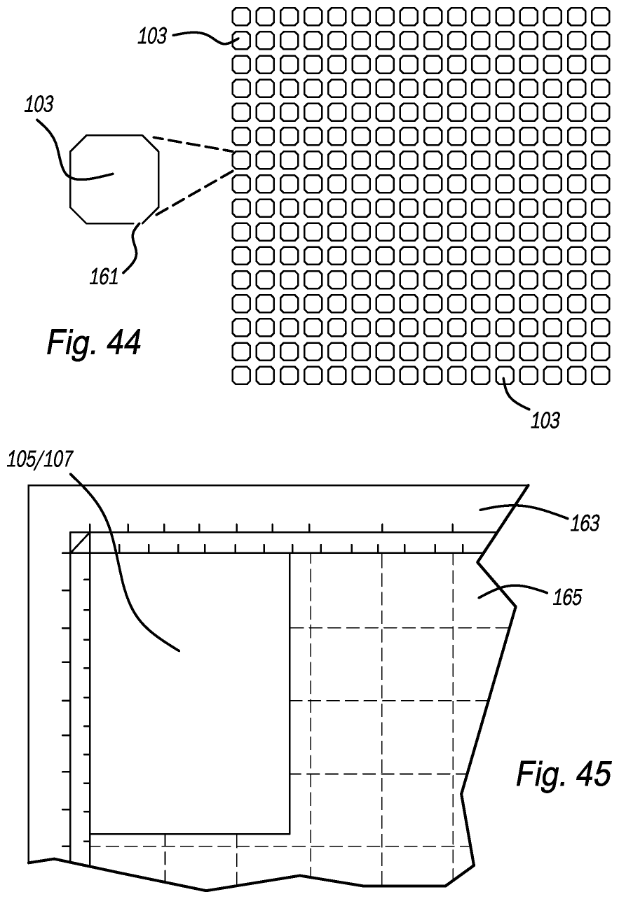

More particularly, the copper electrodes 105 and 107, and piezoresistive film patch 103 outlines are designed for the sensor, as is illustrated in FIGS. 43 and 44, respectively. The outlines are used for a vinyl cutter machine to cut the layers of the sensor. It is noteworthy that the piezoresistive film outline shapes have a small gap 161 so the piezoresistive film shapes are not cut out completely.

Referring to FIGS. 44-46, the sensor array is constructed by using a vinyl cutter machine 163 to cut the copper tape and the piezoresistive film. The outline designs are uploaded to software in the vinyl cutter machine. Using a vinyl cutter is an inexpensive way to make high resolution pressure sensors compared to printing with conductive inks, photo etching, chemical etching, and screen printing. Another advantage of this fabrication method is the ability to customize the shape of the copper electrodes and piezoresistive films such that the sensor can be customized for a specific application. An exemplary vinyl cutting machine is model CM350E ScanNCut 2 from Brother International Corp. Further examples are the Explore Air 2, Mint or Explore 3 models from Cricut, Inc., and model Cameo 4 or model Portrait 3 from Silhouette America, Inc.

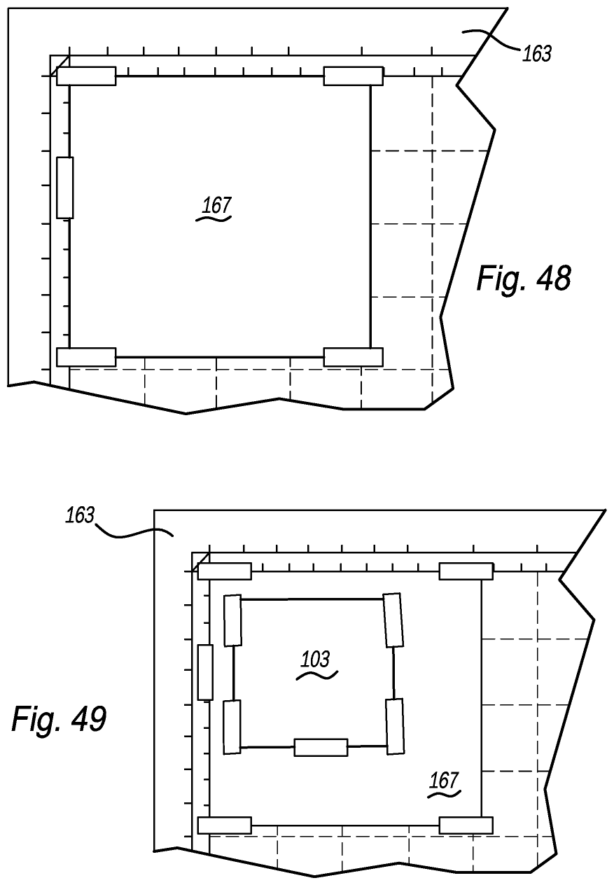

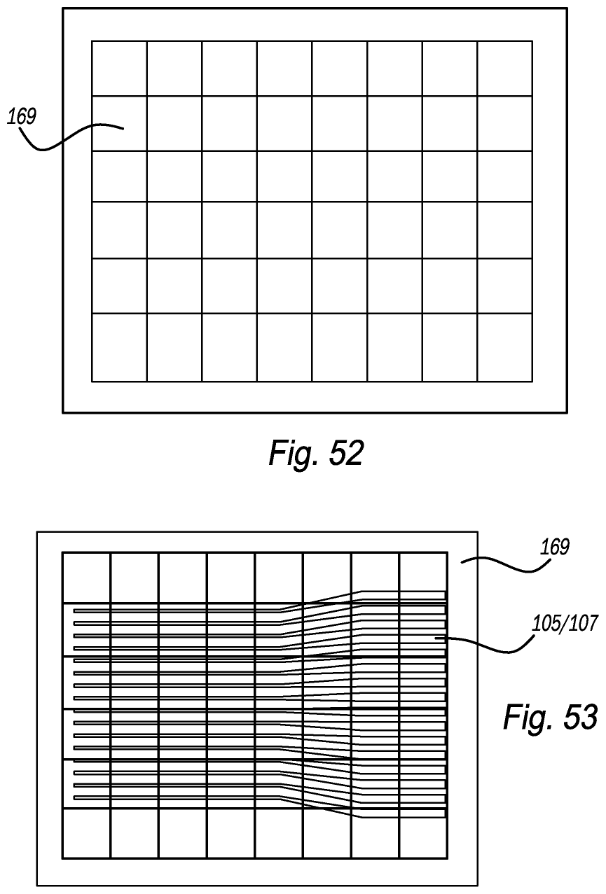

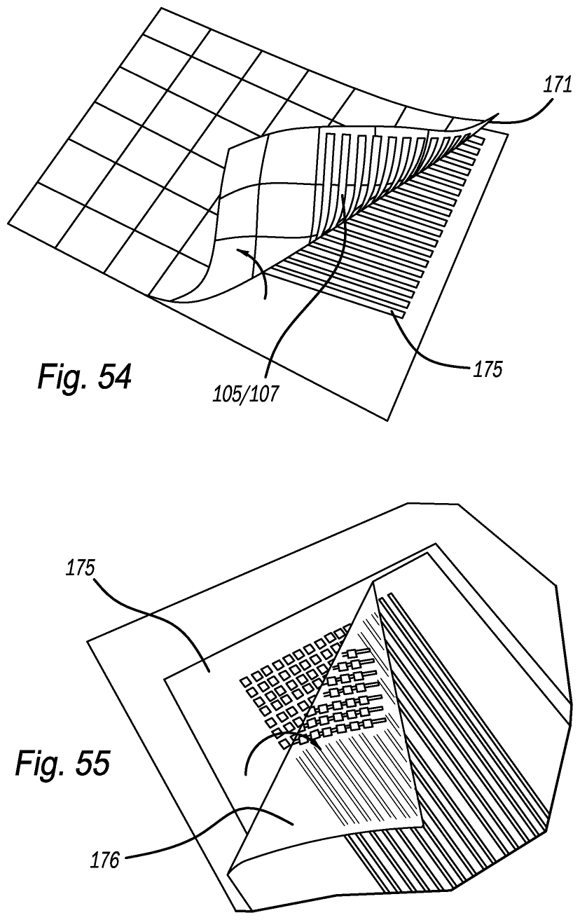

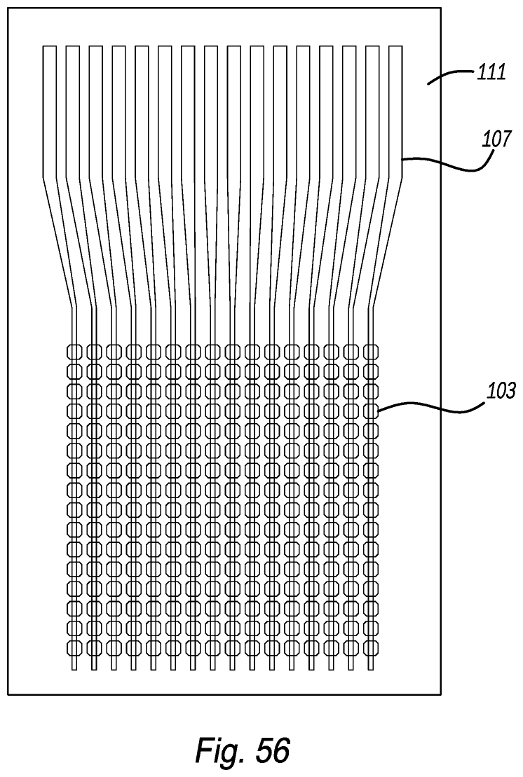

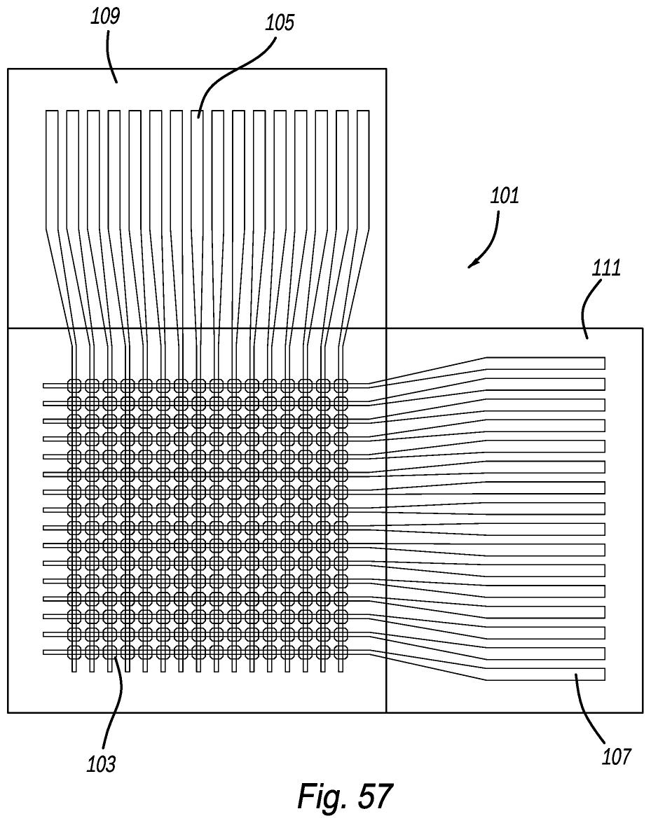

A different description of the manufacturing method of the soft pressure sensor array includes at least the following sequence of steps:
First, FIGS. 43 and 45-47 show the copper tape cut into electrodes 105 and 107 for the top and bottom layers with cutting machine 163, after the outline designs are uploaded and the copper tape is temporarily attached to a mat 165 of the machine.
Second, FIG. 52 illustrates a transfer tape 169 suitable for temporarily sticking to the cut copper tape 105/107 while on the cutting machine.
Third, FIG. 54 shows the undesired offal 175 remaining while the cut copper tape traces 105/107 are being peeled off on transfer tape 171, after removal from the cutting machine.
Fourth, electrodes 105/107 of the remaining cut copper tape for the bottom layer is transferred to the sensor substrate. In the preferred flexible sensor, the substrate is the outer polyester tape. Alternately, an adhesive is applied to an outer substrate film if the substrate is not sticky tape.
Fifth, referring to FIGS. 48-51, the piezoresistive film for patches 103 is temporarily taped onto a larger protective film 167, which is secured to mat 165, and then an array of patches 103 are cut into a grid of squares by cutting machine 163 for the middle pressure sensitive layer.
Sixth, FIG. 55 shows polyester tape 176 being peeled to remove the piezoresistive patches thereon while offal 175 remains behind.
Seventh, the tape with the copper tape traces 107 is then used to attach the piezoresistive film thereto as can be observed in FIG. 56.
Eighth, similar transfer tape and offal removal steps are employed for locating the perpendicular set of electrodes 105 on top of piezoresistive patches 103, as is illustrated in FIG. 57, to complete the final sensor array 101.
   The order of the above steps may be varied, and additional or less manufacturing steps may be used depending on the specific sensor design and machinery used.

There are some alternate embodiments in the fabrication of the sensor. For example, the substrates of the sensor can be made from different materials. The preferred substrates are polyester tapes but the substrates can alternately be a rigid or flexible acrylic plate as the bottom layer, which provides a stiff sensor. Moreover, the substrates that embed the piezoresistive films and electrodes can even be silicone elastomers, which make the sensor soft and stretchable.

Different piezoresistive materials can be used inside the sensor, which gives the sensor different sensitivities. By way of nonlimiting example, a piezoresistive material including a silicone foam mixed with carbon nanotubes (“CNTs”) or silver nanowires (AgNWs) may be employed. Moreover, different types of conductive foils can be used as electrodes other than copper tapes, such as gold electrodes, conductive polymers, conductive fabrics, conductive carbon ink, indium tin oxide coated PET (ITO-PET), or other materials.

### First Experiments

Thirty spawning phase adult sea lampreys were tested on the 10-by-10 pressure sensing panel. The resistance of the pressure sensors at each pixel was measured by a voltage divider with a 1 k ohm reference resistor. An Arduino Mega 2560 microcontroller board provided a 5 V voltage supply for the pressure sensing circuits and generated digital output signals for channel selection. Two analog/digital multiplexer breakout boards (such as SparkFun model CD74HC4067 with 16 channels) were used to choose the circuits between one column and one row of the perpendicular address lines. The output voltage on the reference resistor was measured by a 10-bit Analog-to-Digital Converter (“ADC”) through the analog input.

An exemplary 200 liter experimental water tank was used with the pressure sensing panel placed vertically on the acrylic hanger along a glass wall therein, while the microcontroller board and the voltage divider were adhered on the other side of the hanger. The hanger was clamped on the water tank wall. Furthermore, the water level in the tank was about 5 cm higher than the top row electrode of the 10-by-10 pressure sensing panel, thereby submerging all the sensing area.

In each measurement round, the pressure sensing system scanned the pressure sensors from the top left corner (X=1, Y=1) to the bottom right corner (X=10, Y=10) by selecting the channels of the multiplexers. Resistance was measured consecutively for 20 times at each pressure sensor, and then the average was taken as the measured two-point resistance at that pixel for that time instance. The program repeated the scanning and measurement process every one second (overall sampling rate: 1 Hz) in loops by a timer interrupt.

An adult sea lamprey was transferred to the tank and allowed to explore the tank until it attached to the tank surface via oral suction, after the computer program started to measure the resistance periodically. If the lamprey did not attach onto the sensing area, it would be gently repositioned and held with its mouth over the sensing area until it attached. The top surface of the sensing area was relatively smooth, and experiments showed that most of the tested sea lampreys were able to attach to this sensor for a certain time (e.g., >20 s) after a few trials. As demonstrated in FIG. 19, a sea lamprey 121 attached onto the central area of the sensor 101, with a region spanning almost 4 rows and 4 columns of copper electrodes 107 and 105, respectively, covered by the sea lamprey's oral disc 181. Resistance measurement lasted until the lamprey volitionally detached from the panel or until the first 2 minutes of attachment elapsed. The measurement data would be processed to plot the mapping contours of relative change in the measured resistance directly or would be used to reconstruct the cell resistance first using one of the reconstruction methods noted hereinabove, and then to plot the mapping contours of the relative change in cell resistance.

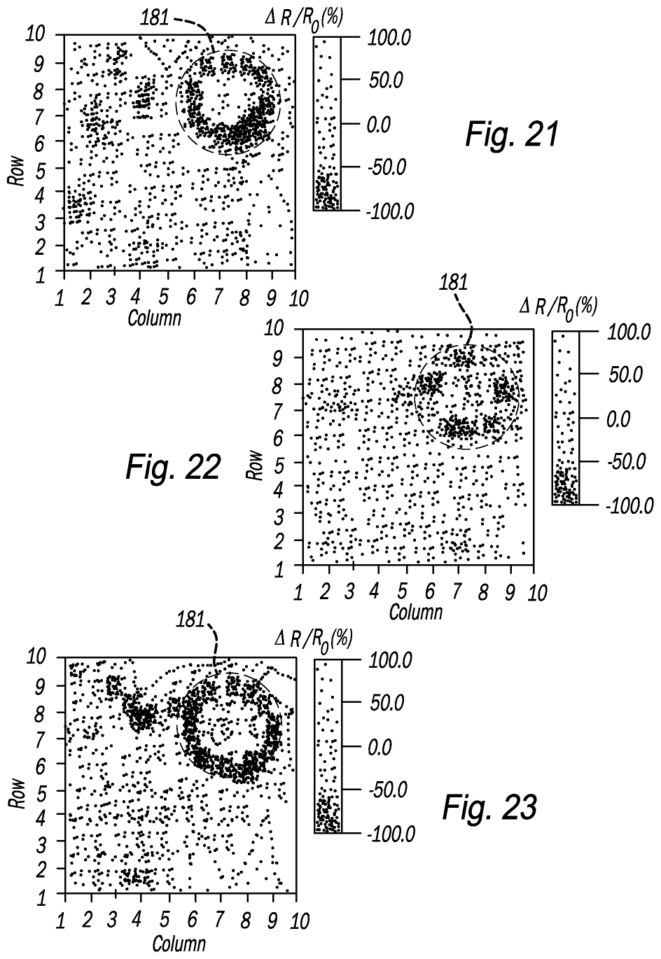

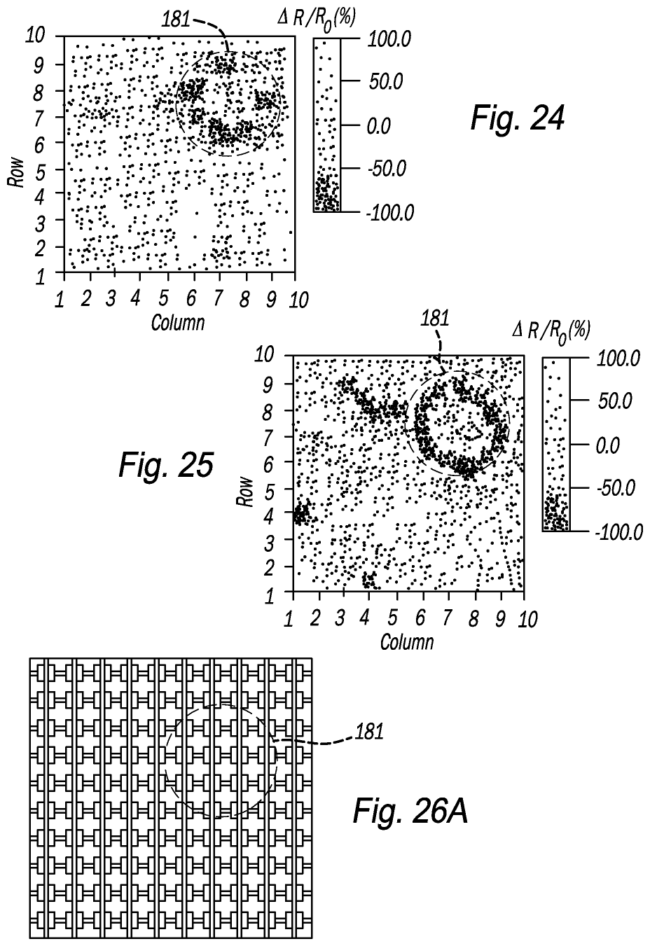

To have a better understanding of all the methods explored above, mapping contours from these methods are displayed in FIGS. 20-25. For each regularization method, a mapping contour with “best” choice of λ is selected—“best”, means visually perceived best tradeoff between data matching and smoothing. FIG. 20 shows the mapping contour of the relative change in the measured resistance (between −82.6% and −1.8%), which is a baseline for all the other results. FIG. 21 is the result from least-squares minimization (LSM algorithm without regularization) with the relative change in cell resistance between −99.5% and 11873.9%, and the following four mapping contours are the results of relative change in cell resistance based on regularization on the cell resistance (LSR-CR algorithm, FIG. 22, λ=0.001, between −94% and 71%), regularization on the relative change in cell resistance (LSR-ΔCR algorithm, FIG. 23, λ=10, between −99.9% and 185%), regularization on the gradient of cell resistance (LSR-∇CR algorithm, FIG. 24, λ=0.001, between −97% and 59%), and lastly regularization on the gradient of relative change in cell resistance (LSR-∇ΔCR algorithm, FIG. 25, λ=10, between −99.9% and 155%), respectively.

As can be observed, (1) directly measured resistance change (FIG. 20) is “blurry” as the measured resistance is related to the cell resistance through a nonlinear filter. (2) Plain LSM (FIG. 21) produces large spikes at some pixels outside of the actual suction area 181, since this reconstruction method is susceptible to the effect of measurement noises and modeling errors. (3) LSR-CR (FIG. 22) and LSR-∇CR (FIG. 23) produce more distinct patterns than directly measured resistance changes while showing pronounced smoothing effect. And (4) LSR-ΔCR (FIG. 24) and LSR-∇ΔCR (FIG. 25) produce the most distinct suction patterns with cell resistance decreased along the rim of oral disc 181 and with cell resistance increased within the oral disc.

In order to further compare the performance of different reconstruction methods, 21 consecutive sets of measured 10-by-10 two-point resistance matrices obtained during the sea lamprey test were used for running these algorithms in MATLAB R2020b on the computer. The computation time and absolute relative error (in percentage) between the derived two-point resistance and the measured two-point resistance were calculated in the form of “mean±standard deviation” and are listed in Table I.

TABLE I
PERFORMANCE COMPARISON OF DIFFERENT METHODS

| | | | Absolute |
|---|---|---|---|
| | | Computation | Relative |
| Method | Specifications | Time [s] | Error [%] |
| LSM | Least Squares Minimization | 16.45 ± 0.40 | 1.33 ± 1.29 |
| LSR-CR | Regularization on Cell | 10.20 ± 2.04 | 7.36 ± 7.85 |
| | Resistance | | |
| LSR-ΔCR | Regularization on Relative | 58.63 | 1.19 ± 1.18 |
| | Change in Cell Resistance | | |
| | Following Steps after | 8.05 ± 0.88 | 1.48 ± 1.51 |
| | Initialization | | |
| LSR-∇CR | Regularization on Gradient | 11.46 ± 1.71 | 5.67 ± 5.28 |
| | of Cell Resistance | | |
| LSR-Δ∇CR | Regularization on Gradient | 60.85 | 1.13 ± 1.13 |
| | of Relative Change in Cell | | |
| | Resistance | | |
| | Following Steps after | 11.01 ± 0.96 | 1.48 ± 1.48 |
| | Initialization | | |

Data are presented in the type of mean ± standard deviation.

For the regularization methods LSR-ΔCR and LSR-∇ΔCR, the initialization step took 58.63 s and 60.85 s, respectively, while the following steps took only 8.05±0.88 s and 11.01±0.96. The reason for significantly longer computation time in the initialization step was because these two methods need to solve both matrices r₀ and r₁ jointly. But for the steps thereafter, the computation time dropped greatly while the absolute relative errors remained within a desirable range. On the other hand, the computation time for method LSM was 16.45±0.40 s, which was larger than the other methods like LSR-CR and LSR-∇CR. Although it had a smaller absolute relative error, the mapping contour did not reflect a perfect visualization result given the noise and the displayed shape. The final decision of reconstruction methods will be a trade-off between the computational complexity, the relative error in data matching, and the smoothing effect.

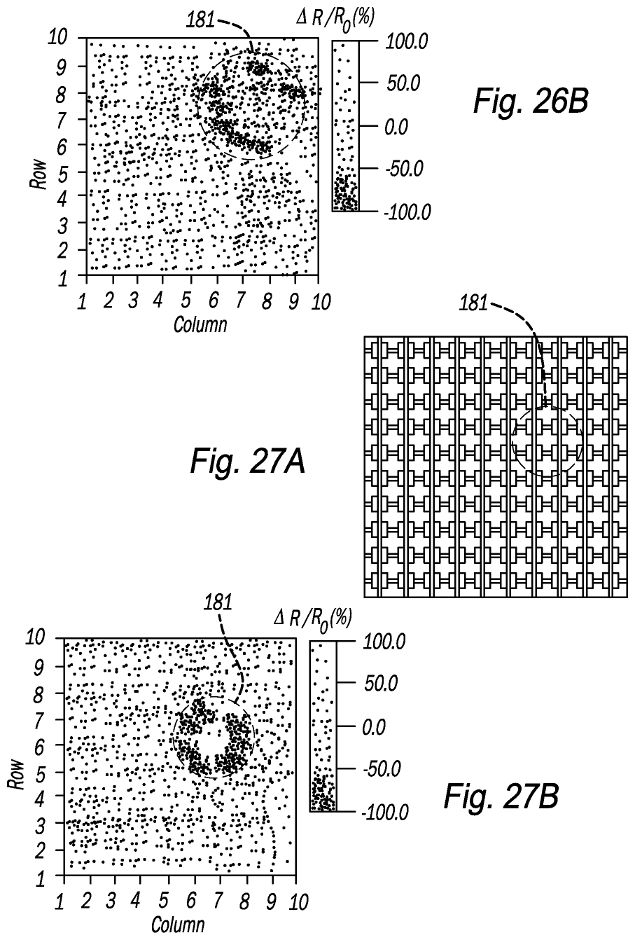

The least-squares regularization method on the gradient of cell resistance (LSR-∇CR) with λ=0.001 was chosen to further show the capability of the present sensor in capturing the demographic information of the detected lampreys. The mapping contours of the 10-by-10 pressure sensing panel under suction and attachment of two different adult sea lampreys are shown in FIGS. 26A-27B. The first adult male sea lamprey had a mouth diameter 181 of 35 mm (FIGS. 26A and B), while the other adult male had a mouth diameter 181 of 25 mm (as shown in FIGS. 27A and B). Therefore, it can be observed that the mapping contour for the larger mouth covered a 4-by-4 grid area (FIG. 26A), while the smaller one covered a 3-by-3 grid area (27A), indicating the ability to successfully measure the size of the sea lamprey's mouth attaching on the sensing panel. This sensed measurement size of the lamprey mouth specimen is also applicable to other types of specimens and uses, such as for alternate in-liquid positive or negative pressures, in-liquid or in-air robotic grippers, wearable sensors and the like.

Thus, the present apparatus provides a low-cost and efficient piezoresistive pressure sensor based on a passive resistor network and algorithms for properly processing the measured data to reconstruct the pressure pattern. For example, in order to recover the cell resistance from the measured two-point resistance, a general inverse mapping relationship is derived based on basic Kirchhoff's current law, and introduces several inverse algorithms based on the least-squares minimization and Tikhonov regularization. These approaches are applicable to a passive resistor network of any size, with the measurement noises and modelling uncertainties taken into consideration. The choice of the value of the regularization parameter λ herein was determined by trying a few values in different orders of magnitude.

A further embodiment of an automated sensing system for detecting sea lamprey attachment based on the present soft pressure sensor array is hereinafter provided. Specifically, machine learning-based object detection algorithms are used to learn features from the measured data of a soft pressure sensor array and perform automatic detection of sea lamprey attachment on the generated mapping contours.

A comprehensive sea lamprey mapping contour dataset is first generated for the training model to learn features. These mappings typically show two different types of patterns under lamprey attachment: a high-pressure circular pattern corresponding to the mouth rim compressed against the sensor (“compression” pattern), and a low-pressure blob corresponding to the partial vacuum region of the sucking mouth (“suction” pattern). Three types of object detection algorithms are deployed for sea lamprey detection, including SSD, RetinaNet, and YOLOv5s (which is a small scale model of YOLOv5 that has fewer layers of convolutional neural networks for faster and simpler object detection tasks). Their validation performance and inference speeds are evaluated and compared in depth, and the results show that YOLOv5s achieves the highest mean average precision (mAP@0.5: 0.95 up to 69.77%), and the fastest inference speed (up to 8.4 ms per image) on the experimental GPU device. Finally, a detection approach based on the YOLOv5s model with a confidence filter unit, is employed. Accordingly, different optimal detection thresholds are employed for the compression and suction patterns, respectively, in order to reduce the false positive rate caused by the sensor's memory effect.

### Second Experiments

This exemplary experiment used a 10×10 soft pressure sensor array (with a sensing area of 10×10 cm²) that was made of the previously described piezoresistive films sandwiched between two layers of perpendicular copper tape electrodes, with polyester tape encapsulated on an acrylic plate. The sensor array formed a resistor network. A resistance at a pixel reduces when a compressive pressure load is applied under the compression of the lamprey mouth rim at each sensor pixel, resulting in a reduction in the corresponding measured resistance via the coupling of the resistor network. Conversely, when a partial vacuum pressure is applied under the suction of the lamprey mouth on a sensor pixel, there will be a rise in the resistance measurement.

As an aside, it has been observed that, likely due to the viscoelasticity of the films and their bonding, the resistance measurements did not immediately return to the at-rest values following the removal of the attachment. This memory effect, which caused some false positives in the detection, is explicitly addressed in the detection algorithm design.

In each measurement round, the pressure sensing system scanned the sensor array from the top left corner to the bottom right corner. Resistance was measured consecutively for 20 times at each pressure sensor, and then the average was taken as the measured two-point resistance at that pixel for that sampling cycle. The program repeated the scanning and measurement process every one second (1 Hz) in loops by a timer interrupt. The resistance measurement data were transferred to the computer.

Meanwhile, the relative change (in %) in the resistance matrix between the current sampling time and the initial value was calculated and converted to a mapping contour plot. An adult sea lamprey was transferred to the tank and introduced to attach onto the sensing area for a certain time (e.g., >20 s) after the program started to measure the resistance periodically. The resistance measurement lasted until the lamprey detached from the panel by itself or until the first 2 minutes of attachment elapsed.

Training models on the sea lamprey dataset will now be discussed. The dataset collected from the sea lamprey experiments on the soft pressure sensor array, were mapped as contour plots converted from the resistance measurements.

A total of 3,094 colored mapping contour plots generated during the sea lamprey attachment periods were collected from 120 groups of sea lamprey experiments, which were annotated with bounding box labels for training and validating the neural networks. Each of these selected mapping contours had a resolution of 640×640 pixels, and was categorized into either “compression” pattern or “suction” pattern based on its overall appearance and contour levels. There were 623 compression plots and 2,471 suction plots.

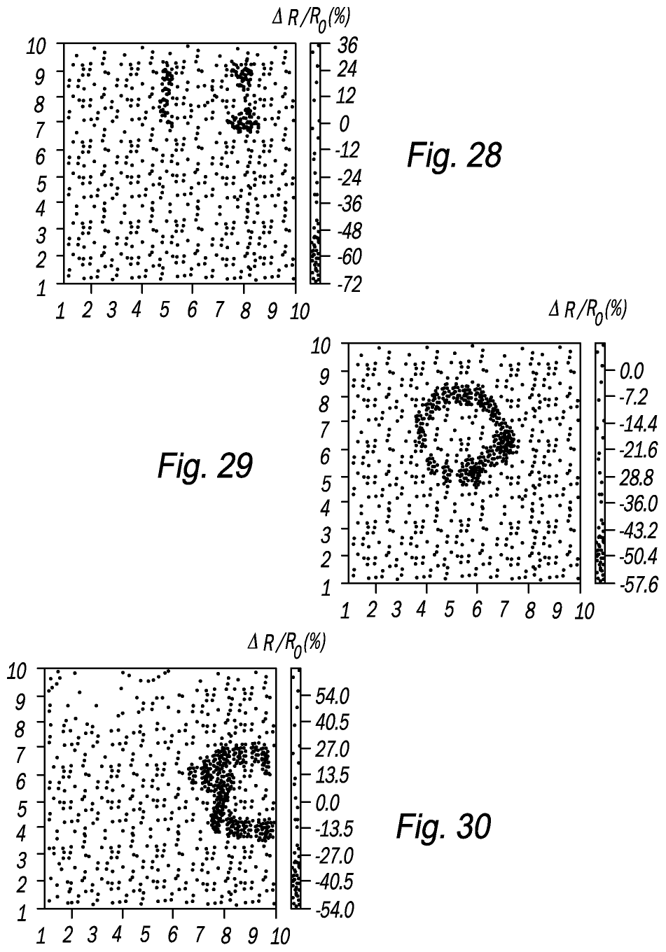

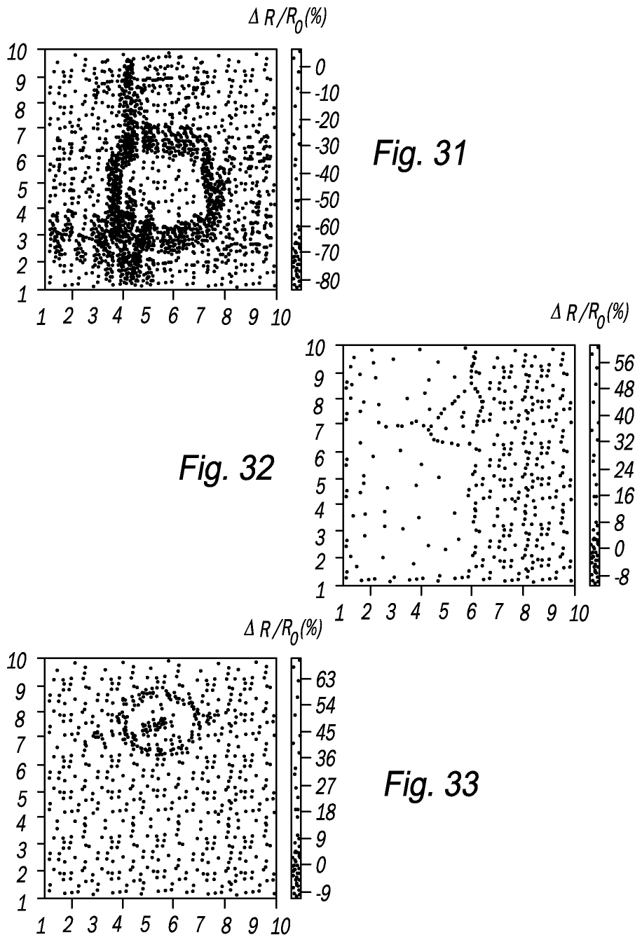

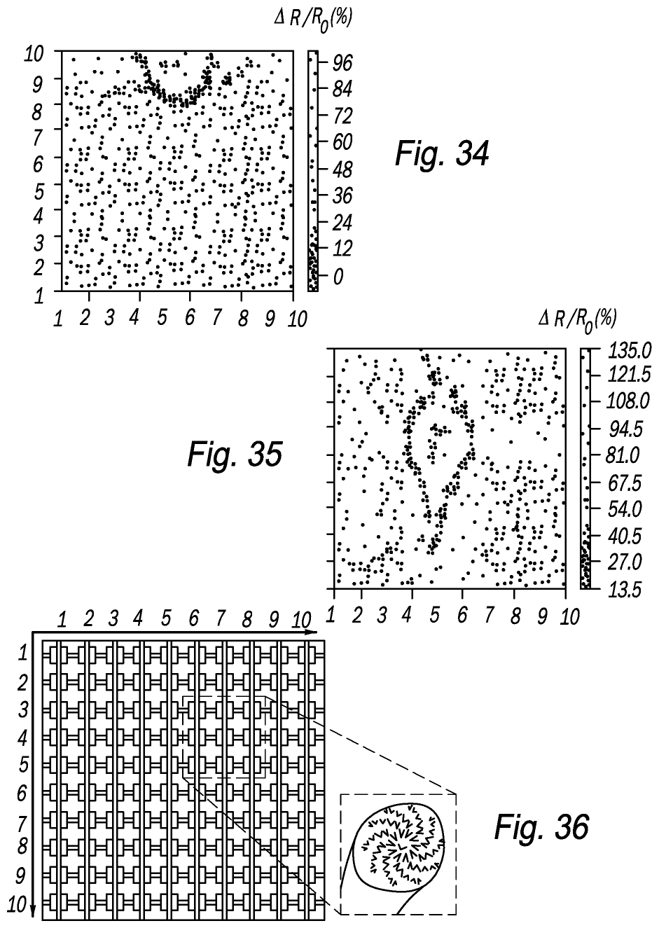

Eight typical mapping contour plots are shown in FIGS. 28-35, including four compression patterns (FIGS. 28-31) and four suction patterns (FIGS. 32-35). For instance, the compression pattern were partial edges or discrete points in more concentrated dark dots in FIG. 28 reflecting non-uniform compression of the lamprey's suction disc on the sensor array, a full circular pattern in more concentrated dark dots in FIG. 29, an arc in more concentrated dark dots on the boundary of FIG. 30, or a corrupted circular pattern of more concentrated dark dots connected to adjacent rows or columns in FIG. 31 due to crosstalk of the sensor array. Similarly, the suction patterns were typically complementary to the compression patterns, which appeared in more concentrated dark dotted blobs.

It is noteworthy that when a mapping contour plot displayed both a compression pattern and a suction pattern, such as FIG. 28, it would still be categorized into only one pattern with the higher magnitude in absolute relative change in resistance. The annotated mapping contour dataset was then split into training and validation subsets with a ratio of 8:2. On the other hand, a total of 3,875 mapping contours obtained from the remaining 20 groups out of the whole 140 sea lamprey experiments were used to test the trained model with a postprocessing filter in order to decide the optimal confidence thresholds for the compression pattern and suction pattern, respectively.

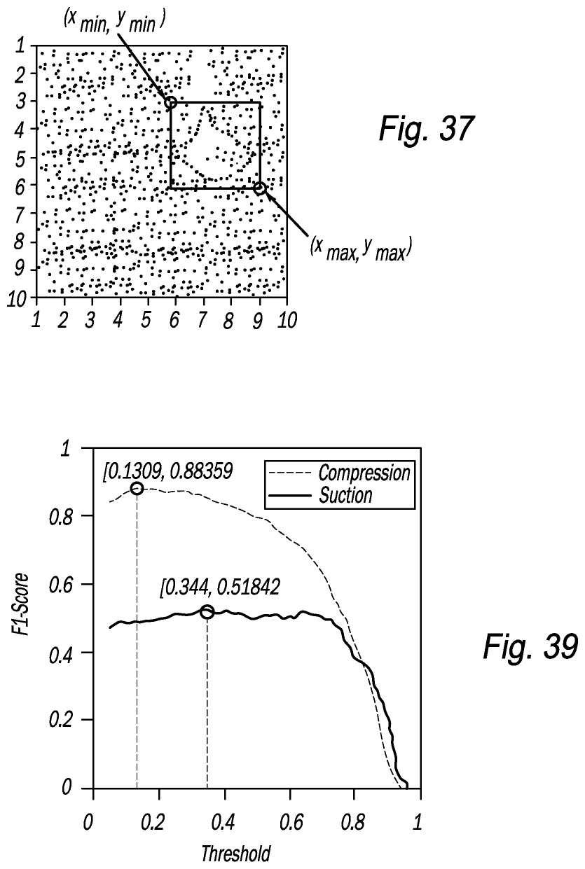

FIGS. 36 and 37 illustrate an example of the annotation of the ground truth bounding box on a suction pattern mapping contour. The coordinates of the ground truth bounding box were obtained from the experimental videos synchronized with the pressure sensor measurements as follows. During the experiments, a cellular phone camera was used to record activities on the whole sensor array. The mapping contour plots in a time sequence from a lamprey experiment were converted to an animation video and the animation contour video was then synchronized with the recorded experimental video. Thereafter, video frames were extracted from the synchronized experimental video every second, with the same frame rate as that for the mapping contour animation video. Finally, the coordinates of the top left vertex (Colₘᵢₙ, Rowₘᵢₙ) and the bottom right vertex (Colₘₐₓ, Rowₘₐₓ) of the ground truth bounding box were estimated with one decimal point between the boundary limits of 1.0 and 10.0.

Different object detectors may accept different formats of bounding box labels. The RetinaNet framework uses (class, xmin, ymin, xmax, ymax) as its label format, where class is either 0 or 1, which represents “compression” or “suction” pattern, respectively; (xₘᵢₙ, yₘᵢₙ) denotes the pixel coordinates of the top left vertex, and (xₘₐₓ, yₘₐₓ) denotes those of the bottom right vertex, which can be obtained from the row and column coordinates:

$$\begin{matrix}{x}_{min} = ( \frac{{Col}_{min} - 1}{10 - 1} \cdot {r}_{w} + {r}_{lm} ) \cdot {Fig}_{w} & ( 2 ) \\ {x}_{max} = ( \frac{{Col}_{max} - 1}{10 - 1} \cdot {r}_{w} + {r}_{lm} ) \cdot {Fig}_{w} & ( 3 ) \\ {y}_{min} = ( \frac{{Row}_{min} - 1}{10 - 1} \cdot {r}_{h} + {r}_{tm} ) \cdot {Fig}_{h} & ( 4 ) \\ {y}_{max} = ( \frac{{Row}_{max} - 1}{10 - 1} \cdot {r}_{h} + {r}_{tm} ) \cdot {Fig}_{h} & ( 5 )\end{matrix}$$

where the meanings of the parameters can be found in Table II.

TABLE II
PARAMETERS FOR GENERATING
THE MAPPING CONTOUR PLOTS.

| Name | Variable | Value |
|---|---|---|
| Figure width | Fig_{w} | 640 |
| Figure height | Figₕ | 640 |
| Ratio of contour width to figure width | r_{w} | 0.9 |
| Ratio of contour height to figure height | rₕ | 0.9 |
| Ratio of contour left margin to figure width | rₗₘ | 0.05 |
| Ratio of contour top margin to figure height | rₜₘ | 0.05 |
| Colormap style | cmap | 0.05 |
| Number of contour levels | Nₗₑᵥₑₗ | 100 |
| Colorbar min limit | vₘᵢₙ | −100 |
| Colorbar max limit | vₘₐₓ | 100 |

On the other hand, in addition to the class label, the SSD and YOLOv5 object detection models take the normalized coordinates of the bounding box center (x_{center}, y_{center}), and the normalized width w_{bbox} and height h_{bbox} of the bounding box as accepted labels, and the formulas are given below:

$$\begin{matrix}{x}_{center} = ( \frac{\frac{{Col}_{min} + {Col}_{max}}{2} - 1}{10 - 1} \cdot {r}_{w} + {r}_{lm} ) & ( 6 ) \\ {y}_{center} = ( \frac{\frac{{Row}_{min} + {Row}_{max}}{2} - 1}{10 - 1} \cdot {r}_{h} + {r}_{tm} ) & ( 7 ) \\ {w}_{bbox} = \frac{{Col}_{max} - {Col}_{min} - 1}{10 - 1} \cdot {r}_{w} & ( 8 ) \\ {h}_{bbox} = \frac{{Row}_{max} - {Row}_{min} - 1}{10 - 1} \cdot {r}_{h} & ( 9 )\end{matrix}$$

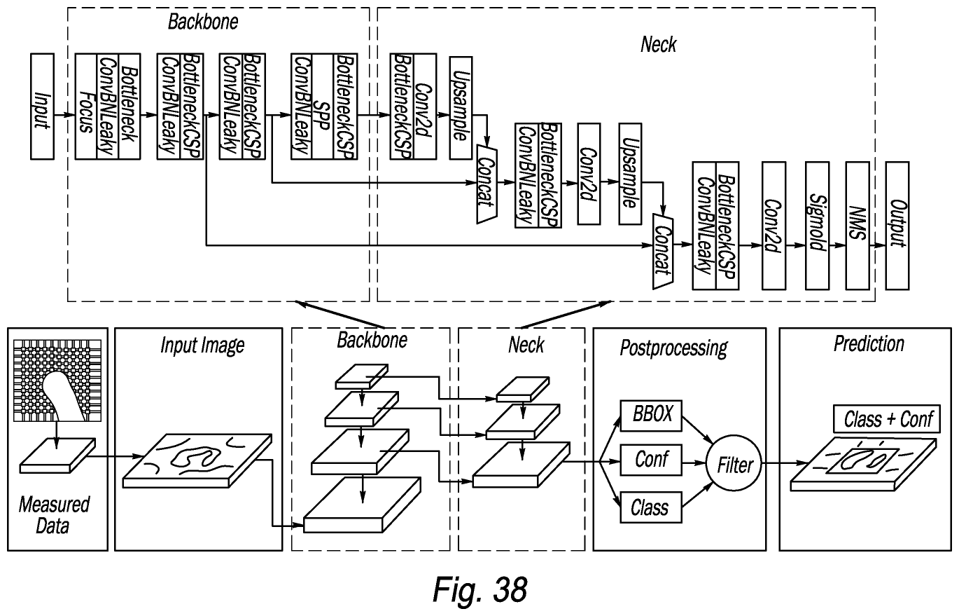

Filtered YOLOv5s for mitigation of the sensor memory effect is set forth hereafter. This section presents a real-time automated sea lamprey detection approach using an object detection method. Referring now to FIG. 38, the YOLOv5s model-based sea lamprey detection neural networks consisted of three parts: a deep convolutional neural network backbone extracting feature maps from the input mapping contour image, a top-down architecture network neck constructing multi-scale feature maps, and a confidence score filter end. The backbone and the neck directly learned features from the measurements of a soft pressure sensor array and then predict bounding box, class, and confidence of the input contour image. Meanwhile, due to the soft pressure sensor's memory effect, the detection network viewed the leftover patterns following the detachment as a normal compression or suction pattern, which could cause false positives in prediction. In order to mitigate such memory effect-induced faulty detection, a postprocessing head that filters the confidence of the compression pattern and suction pattern separately was added to the sea lamprey detection network. Each of three aforementioned elements is elaborated next.

The learning networks of YOLOv5s mainly used three Bottleneck Cross Stage Partial (“BottleneckCSP”) Networks as its backbone. The backbone firstly adopted a Focus layer to slice the input images and reshape the dimensions, then four ConvBNLeaky modules were deployed interdigitatedly between the BottleneckCSP modules, each of which contained a convolution layer that is connected with a batch normalization (“BN”) layer and a LeakyReLU activation layer. After the last ConvBNLeaky layer, a Spatial Pyramid Pooling (“SPP”) module was used to remove the fixed-size constraint of the networks. The feature maps extracted from three levels of the backbone were merged to the following neck part at three corresponding levels.

The feature fusion neck of YOLOv5s was constructed in a top-down Feature Pyramid Network (“FPN”) for building high-level semantic feature maps at all scales. These features were then enhanced with the features from the previous bottom-up pathway via lateral connections by concatenation, and the fused feature maps was transferred to a ConvBNLeaky layer followed by another BottleneckCSP network and a basic 2D convolution layer. The inference output was sent to a sigmoid activation layer to regress the normalized bounding box center coordinates and the normalized widths and heights. Finally, a non-maximum suppression (“NMS”) technique was applied to select the best bounding boxes from multiple candidates.

After the feature fusion block, bounding box candidates of predicted sea lamprey attachment were obtained. Each of the valid candidates contained a pair of normalized center coordinates, a pair of normalized width and height, a class label, and a final confidence score. The confidence score was a probability that an object belongs to one class, which means the product of the object confidence Conf_{obJ} and the class confidence Conf_{cls}. The object confidence was calculated from the intersection over union (“IoU”) between the predicted bounding box and the ground-truth bounding box.

$$\begin{matrix}{IoU}_{pred}^{g - t} = \frac{Area of Intersection}{Area of Union} & ( 13 ) \\ {Pr}_{obj} = \{ \begin{matrix}0 , & if {IoU}_{pred}^{g - t} = 0 \\ 1 , & otherwise\end{matrix} & ( 14 ) \\ {Conf}_{obj} = {Pr}_{obj} \cdot {IoU}_{pred}^{g - t} & ( 15 )\end{matrix}$$

The class confidence was a conditional probability of the class when there

is an object being predicted at that cell:

Conƒ_{cls}=Pr_{cls|obj} (16)

So, the final confidence score can be written as

Conƒ=Conƒ_{cls}·Conƒ_{obj}=Pr_{cls|obj}·Pr_{obj}·IoU_{pred}^{g-t} (17)

The trained YOLOv5s model achieved a good performance for the sea lamprey compression or suction pattern detection. Nevertheless, imperfect prediction of sea lamprey attachment was found on many lamprey experiments in the testing dataset. The soft pressure sensor had some inherent memory effect when the compression was removed or when the suction pressure was released. Such a memory effect often lasted for more than 10 seconds after the lamprey detached from the sensor array. Furthermore, the overall memory effect showed a relatively low confidence score, thus it is promising to mitigate the false prediction by setting an additional postprocessing module with a higher threshold. Note that in most cases, the memory effect was more pronounced when the suction was removed than when the compression was removed from the sensor, two different confidence thresholds were set for the compression pattern and the suction pattern, respectively.

The final confidence scores were fed into a confidence filter to remove all the bounding box predictions with a confidence score less than a designed threshold. This filtering process proved to be effective for suppressing the sensor's memory effect as it only outputs the bounding box information in the beginning of the hardware's memory stage, and prevented false detection in the remaining time. Two separate confidence thresholds (θc and θs) for the compression pattern and the suction pattern, respectively, were optimally selected. The output was given according to the confidence value and the confidence threshold of that class:

$$Output = \{ \begin{matrix}{BBox}_{compression} , & if class = 0 and Conf ⩾ {θ}_{C} \\ {BBox}_{suction} , & if class = 1 and Conf ⩾ {θ}_{S} \\ None , & otherwise\end{matrix} \qquad ( 18 )$$

The testing dataset from the remaining 20 groups of sea lamprey experiments was used for testing the trained YOLOv5s model and getting class and confidence scores. Then the results with the ground-truth labels were investigated in depth to find the optimal confidence thresholds that could not only improve the positive predictions but also suppress false positive predictions.

The testing output dataset was first split into four groups: the true compression subset, the false compression subset, the true suction subset, and the false suction subset. For the compression subsets, a confidence threshold (θc) was set as a variable, changing from 0.05 to 1.0. According to this compression confidence threshold, the compression prediction dataset could be divided into four categories: true positive compression (“TPC”), false positive compression (“FPC”), true negative compression (“TNC”), and false negative compression (“FNC”). The corresponding true positive rate, false positive rate, true negative rate, and false negative rate for the compression pattern are noted as TPRC, FPRC, TNRC, FNRC, respectively. In this way, the precision (“PC”), recall (“RC”), and the F-1 Score (“F1C”) of the compression pattern was evaluated as follows.

$$\begin{matrix}{P}_{C} ( {θ}_{C} ) = \frac{TPRC ( {θ}_{C} )}{TPRC ( {θ}_{C} ) + FPRC ( {θ}_{C} )} & ( 19 ) \\ {R}_{C} ( {θ}_{C} ) = \frac{TPRC ( {θ}_{C} )}{TPRC ( {θ}_{C} ) + FNRC ( {θ}_{C} )} & ( 20 ) \\ F {1}_{C} ( {θ}_{C} ) = \frac{2 \cdot {P}_{C} ( {θ}_{C} ) \cdot {R}_{C} ( {θ}_{C} )}{{P}_{C} ( {θ}_{C} ) + {R}_{C} ( {θ}_{C} )} & ( 21 )\end{matrix}$$

Here F-1 score was a metric that balances the precision and the recall using their harmonic mean. The performance evaluation metrics for the suction pattern was obtained similarly from the suction dataset. Then, the F-1 score curves of both compression and suction patterns can be drawn, as shown in FIG. 39. The maximum F-1 score is achieved as 0.88359 and 0.51842, when the confidence threshold is 0.1309 for the compression pattern, and 0.344 for the suction pattern, respectively.

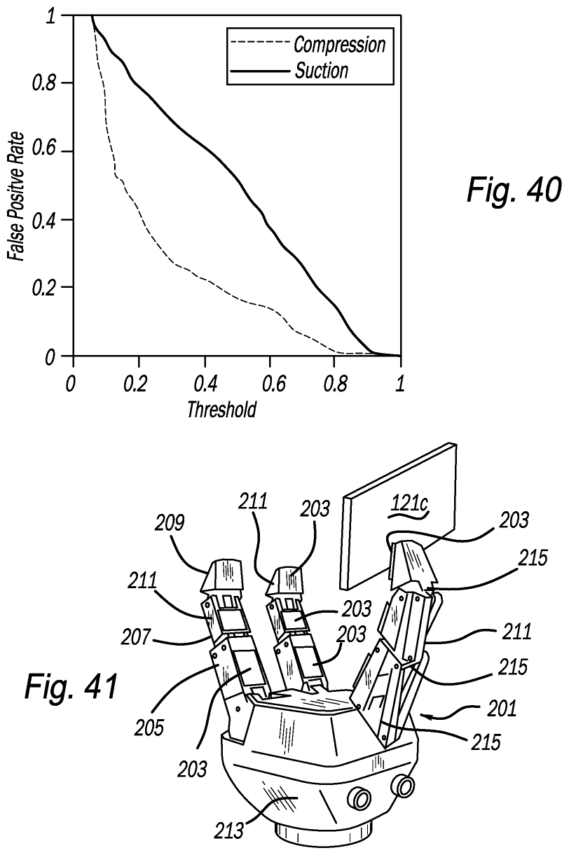

In the meantime, the corresponding false positive rate curves are shown in FIG. 40, which were directly related to the faulty detection due to the memory effect. When the maximum F-1 score is achieved for the compression pattern and the suction pattern, respectively, the corresponding false positive rate reaches 0.51923 and 0.65431, separately. Moreover, the higher the confidence threshold is, the lower the false positive rate for both compression and suction patterns. However, this affects the F-1 score as well, and would possibly reduce it when the threshold is too high. Therefore, both the F-1 score and the FPR are taken into consideration in order to determine a “trade-off” between high positive prediction and low false prediction. This was realized by introducing a regularization co-efficient to the following cost function:

L_{C}(θ_{C})=F1_{C}(θ_{C})−λ·FPRC(θ_{C}) (22)

where λ [symbol] 0 is the regularization (or penalty) parameter, which controls the relative importance of the F-1 score with regard to the regularization FPR term, and the subtract operation is used since higher F-1 score and lower FPR are desirable. The choice of the value of the regularization parameter λ can be determined by the specific purpose or focus of that application.

Moreover, the optimal confidence threshold θC for the compression pattern was selected in order to maximize this cost function:

$${\hat{θ}}_{C} = arg {max}_{{θ}_{C}} {L}_{C} ( {θ}_{C} ) \qquad ( 23 )$$

The cost function and the optimal confidence threshold for the suction pattern can be similarly achieved.

Accordingly, the present apparatus and method achieve automated soft pressure sensor array-based sea lamprey detection using object detection neural networks, with a designed confidence threshold to mitigate the sensor's memory effect before final prediction outputs. In summary, the present apparatus and method first collected a comprehensive sea lamprey dataset of attachment mapping contours with two major patterns: “compression” and “suction” patterns, and annotated the dataset with ground-truth bounding box and class estimated from the synchronized experimental videos. Then different object detection models were trained and validated on this sea lamprey dataset. By evaluating their overall performance, the YOLOv5s model was selected as the preferred sea lamprey detection approach. Moreover, to achieve the best precision and suppress false prediction due to the sensor's memory effect, a postprocessing unit was added to the YOLOv5s model with two different confidence thresholds for the two categories of patterns. And the trade-off between higher precision and lower false positive rate was achieved by a regularization method.

A beneficial aspect of the present automated contact detection algorithm is to convert tactile perception into visual perception. Specifically, this detection system uses computer vision technology to analyze the raw measurement data collected from the soft pressure sensor array, and, after the machine learning model has been well trained, it does not thereafter require a camera to record video or images in the detection/inference process. With this advantage, the present system is not only robust against some undesirable environments, but also achieves low data storage costs and volume. It provides straightforward position and contact pattern detection using object detection convolutional neural networks. Furthermore, this visualization approach makes it easier for the user to observe the predicted information on an output display and intervene during the detection process, if needed.

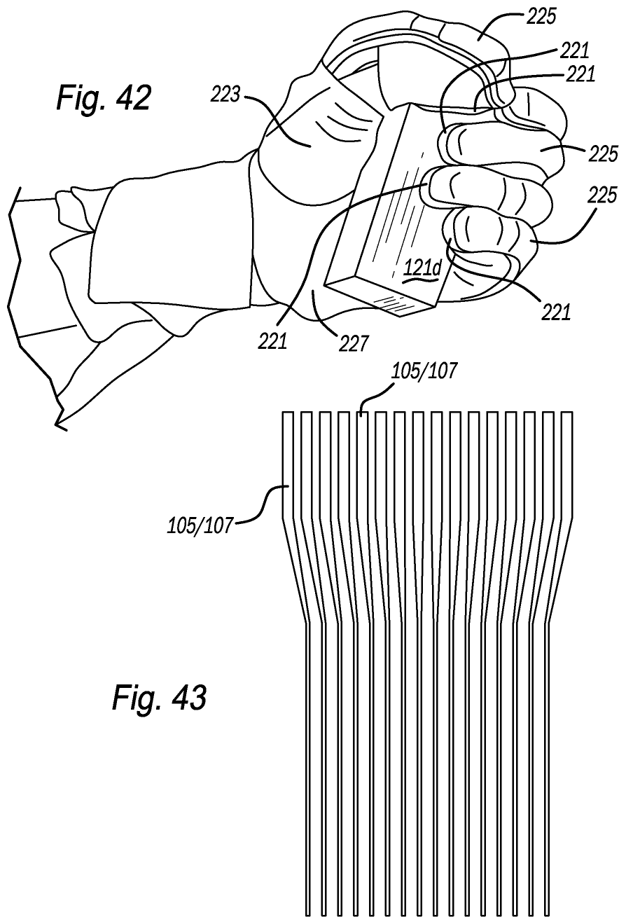

Reference should now be made to FIGS. 41 and 42. In alternate embodiments illustrated therein, the present sensor apparatus and method can be used in a wide range of applications in soft robotics, wearable devices, electronic skins, tactile sensing, human-robot interaction, virtual reality, underwater exploration and biomonitoring. The sensors of these gripping embodiments are constructed, manufactured and function essentially the same as with the preferred embodiment, including the algorithms, software and methods associated therewith.

In the configuration shown in FIG. 41, a robotic gripper 201 has one or more flexible sensors 203 mounted on digit section 205, 207 and 209 of multiple articulated fingers 211, which are pivotably connected to each other and a wrist 213 by articulated joints 215. Wrist 213 is movably coupled to an elongated arm of a computer controlled and floor-mounted articulated robot, an overhead gantry robot or the like. Sensors 203 operably sense the compression force suction cup negative pressure of a workpiece 121c held therein. Such workpieces include delicate and crushable fruit, vegetables, eggs or the like, or more rigid members such as metallic sheets, circuit boards, optics, windows or the like.

The exemplary version shown in FIG. 42 provides one or more flexible sensors 221 embedded in a human-wearable soft robotic arm cover or hand-worn glove 223 to provide tactile sensing of a crushable or rigid workpiece specimen 121d in contact therewith. The sensor may be interwoven in the fabric of the glove or externally adhered to the workpiece-contacting surfaces of finger portions 225 and a palm portion 227 thereof. This may facilitate home-based rehabilitation for stroke survivors with hand impairment through repetitive stretching exercises. In an additional variation, the sensor array can also sense bending, which can be used to measure the bending in joints of the glove or gripper.

Alternately, the sensor could be used for underwater exploration in low-visibility undersea environments. For instance, this sensor device is usable for exploring and servicing undersea equipment such as working under a pier, oil extraction platform, salvaging shipwrecks and navigating through underwater caves and the like, especially in low-visibility turbid media in deep sea environments. This sensor will also enable remote operations of underwater vehicles for real-time prediction of objects around and those being operated on, such as for autonomously controlled submergible watercraft or remotely controlled watercraft.

While various features of the present apparatus and method have been disclosed, it should be appreciated that other variations may be employed. For example, different shapes and sizes of the electrodes can be employed, although various advantages of the present apparatus may not be realized. Furthermore, a different electrical circuit and electronic components can be used with the present sensors, but certain cost and performance benefits may not be obtained. It is also envisioned that different algorithms or manufacturing steps and machines can be used as long as they achieve similar functionality to those disclosed herein, however, certain benefits may not be realized. Additionally, alternate materials can be employed, although performance and cost may differ. Features of each of the embodiments and uses may be interchanged and replaced with similar features of other embodiments, and all of the claims may be multiply dependent on each other in any combination. Variations are not to be regarded as a departure from the present disclosure, and all such modifications are intended to be included within the scope and spirit of the present invention.

The invention claimed is:

1. A sensor apparatus comprising:
a first set of elongated conductive electrodes;
a second set of elongated conductive electrodes arranged at an offset angle from and crossing the first set of electrodes;
resistive members, including a polymeric material with conductive particles therein, each being located between the first and second sets of electrodes where they cross; and
a controller being configured to calculate at least one regularized least-squares algorithm to reconstruct resistance values of the resistive members based on measured resistance values between row and column electrodes, to reduce cross-talk between the resistive members.

2. The apparatus of claim 1, wherein:
each of the first and second sets of electrodes have an elongated length greater than a greatest linear dimension of each of the resistive members;
the first set of electrodes includes at least four parallel and spaced apart metal electrode traces;
the second set of electrodes includes at least four parallel and spaced apart metal electrode traces;
the resistive members are spaced apart from each other; and
there are at least sixteen of the resistive members with one at each crossing location of the electrode traces.

3. The apparatus of claim 1, wherein:
the resistive members include piezoresistive film;
the resistive members and the electrodes are waterproof encapsulated within polymeric outer layers; and
the electrodes and the outer layers are flexible.

4. The apparatus of claim 1, wherein:
the resistive members and the sets of electrodes create a resistor network in an electrical circuit which introduces cross-talk between adjacent of the resistive members with a measured two-point resistance being influenced by other of the resistive members in the network; and
the algorithm includes a machine learning algorithm based on mapping contour images as input, which are plotting from a relative change in measured resistance.

5. The apparatus of claim 1, wherein:
the algorithm includes a machine learning algorithm based on mapping contour images as input, which are plotting from a relative change in measured resistance; and
the algorithm is configured to predict a class, confidence and bounding box of a contact characteristic for each frame of the images and then use a confidence filter to output predicted information.

6. The apparatus of claim 1, wherein:
the algorithm includes a machine learning algorithm based on mapping contour images as input, which are plotting from a relative change in measured resistance; and
the algorithm is configured to recurrent neural networks to analyze time sequence data of an output class, confidence and bounding box of a contact characteristic.

7. The apparatus of claim 1, further comprising software instructions, stored in non-transient memory of the controller, which are configured to operate in a real-time and feedback looped manner to:
convert measured resistance matrix to the mapping contour images;
detect a position and different contact patterns; and
correct a detection result with a confidence filter.

8. The apparatus of claim 1, wherein:
the resistive members and the sets of electrodes create a resistor network in an electrical circuit which introduces cross-talk between adjacent of the resistive members with a measured two-point resistance being influenced by other of the resistive members in the network; and
the algorithm is configured to use data matrices of a relative change in measured resistance as an input and to send an output from a multilayer perceptron network.

9. The apparatus of claim 1, wherein the controller senses suction pressure from the electrodes due to an electrical signal created by increased resistance.

10. The apparatus of claim 1, wherein the controller senses a magnitude of positive pressure from the electrodes due to an electrical signal created by decreased resistance.

11. The apparatus of claim 1, further comprising a gripper movably coupled to a computer controlled robot, the electrodes and resistive members are mounted on the gripper, and the gripper is configured to grip crushable fruit, vegetables or eggs.

12. The apparatus of claim 1, further comprising a human-wearable cover or glove, and the electrodes and resistive members are mounted on the cover or glove.

13. A sensor apparatus comprising:
a first set of at least four elongated and conductive electrodes, which are parallel and spaced apart from each other;
a second set of at least four elongated and conductive electrodes, which are parallel and spaced apart from each other;
the second set of electrodes crossing the first set of electrodes;
polymeric resistors including conductive particles therein, each of the resistors being located between the first and second sets of electrodes where they cross, and the resistors being spaced apart from each other; and
each of the electrodes have an elongated length greater than a greatest linear dimension of each of the resistors;
wherein there are at least sixteen of the resistors with one at each crossing location of the electrodes.

14. The apparatus of claim 13, wherein:
the resistors include piezoresistive film;
the resistors and the electrodes are waterproof encapsulated within polymeric outer layers; and
the electrodes and the outer layers are flexible.

15. The apparatus of claim 13, further comprising a controller being configured to calculate at least one regularized least-squares algorithm to reconstruct resistance values of the resistors based on measured resistance values between row and column electrodes, to reduce cross-talk between the resistors.

16. The apparatus of claim 13, wherein:
the resistors and the electrodes create a resistor network in an electrical circuit which introduces cross-talk between adjacent of the resistors with a measured two-point resistance being influenced by other of the resistors in the network; and
a machine learning algorithm based on mapping contour images as input, which is plotted from a relative change in measured resistance.

17. The apparatus of claim 13, further comprising software instructions, stored in non-transient computer memory, which are configured to operate in a real-time and feedback looped manner to:
convert measured resistance matrix to mapping contour images;
detect a position and different contact patterns; and
correct a detection result with a confidence filter.

18. The apparatus of claim 13, further comprising a programmable controller sensing suction pressure from the electrodes due to an electrical signal created by increased resistance.

19. The apparatus of claim 13, further comprising a programmable controller sensing a magnitude of positive pressure from the electrodes due to an electrical signal created by decreased resistance.

20. The apparatus of claim 13, further comprising a gripper movably coupled to a computer controlled robot, the electrodes and resistors are mounted on the gripper, and the gripper is configured to grip crushable fruit, vegetables or eggs.

21. The apparatus of claim 13, further comprising a human-wearable cover or glove, and the electrodes and resistors are mounted on the cover or glove.

22. A sensor apparatus comprising:
a first set of electrodes;
a second set of electrodes;
the second set of electrodes crossing the first set of electrodes;
compressible resistors sandwiched between the first and second sets of electrodes where they cross, and the resistors being spaced apart from each other;
polymeric outer layers encapsulating the electrodes and the resistors therein in a waterproof manner;
the sensor apparatus being flexible; and
the sensor apparatus being configured to sense suction pressure thereon.

23. The apparatus of claim 22, wherein:
each of the first and second sets of electrodes have an elongated length greater than a greatest linear dimension of each of the resistors;
the first set of electrodes includes at least four parallel and spaced apart metal electrode traces;
the second set of electrodes includes at least four parallel and spaced apart metal electrode traces; and
there are at least sixteen of the resistive members with one at each crossing location of the electrode traces.

24. The apparatus of claim 22, further comprising:
a gripper movably coupled to a computer controlled robot, the electrodes and resistors are mounted on the gripper, and the gripper is configured to grip crushable fruit, vegetables or eggs; and
the resistive members including at least one of: piezoresistive film or carbon nanoparticles in a polymer.

25. A method of manufacturing a flexible sensor, the method comprising:
(a) cutting metallic electrodes from a flexible layer with a programmable vinyl-cutter machine;
(b) cutting piezoresistive patches from a film with the programmable vinyl-cutter machine;
(c) orienting an upper set of the electrodes offset from a lower set of the electrodes; and
(d) sandwiching the patches between the upper and lower sets of the electrodes after steps (a) and (b).
